(19) United States
(12) Patent Application Publication
(10) Pub. No.: US 2026/0200778 A1
(43) Pub. Date: Jul. 16, 2026

(54) WASTEWATER TREATMENT DEVICES, SYSTEMS, AND METHODS

(71) Applicant: University of Washington, Seattle, WA (US)

(72) Inventors: Mari-Karoliina Henriika Winkler, Seattle, WA (US); Bruce J. Godfrey, Seattle, WA (US); Bo Li, Seattle, WA (US)

(73) Assignee: University of Washington, Seattle, WA (US)

(21) Appl. No.: 19/133,101

(22) PCT Filed: Nov. 27, 2023
(86) PCT No.: PCT/US2023/081192

§ 371 Date: May 27, 2025

Related U.S. Application Data
(60) Provisional application No. 63/385,182, filed on Nov. 28, 2022.

(51) Int. Cl. C02F 3/30; C02F 3/34; C02F 101/16

(52) U.S. Cl. CPC C02F 3/301; C02F 3/341; C02F 3/348; C02F 2101/16; C02F 2209/02; C02F 2209/22

(57) ABSTRACT

Devices, systems, and methods for combined multi-process treatment of wastewater, waste gas streams, or a gas flow that includes hydrogen gas. A water treatment device includes a hollow fiber membrane with an exterior biofilm coating that includes a first microorganism for a first process that utilizes a gas that diffuses from an interior of the membrane. The membrane is disposed within a bulk liquid that includes a hydrogel bead that carries a second microorganism for a second process. The second process can utilize a product of the first process. The first process can include an anaerobic process, such as biomethanization, or an aerobic process, such as nitrification. An aerobic first process causes a decreasing oxygen gradient in the bulk liquid that allows for an anaerobic process, such as denitrification, for the second process. The disclosure provides continuous-flow bioreactors that provide distinct niches for microorganisms that have different culture requirements.

### CROSS-REFERENCE(S) TO RELATED APPLICATION(S)

This PCT application claims the benefit of U.S. Provisional Patent Application No. 63/385,182 filed on Nov. 28, 2022, the content of which is incorporated by reference herein in its entirety for all purposes.

### STATEMENT REGARDING SEQUENCE LISTING

The Sequence Listing XML associated with this application is provided in XML format and is hereby incorporated by reference into the specification. The name of the XML file containing the sequence listing is 3915-P1286WOUW_Sequence_Listing.xml. The XML file is 13,438 bytes; was created on Nov. 9, 2023; and is being submitted electronically via Patent Center with the filing of the specification.

### BACKGROUND

Treatment of water in the U.S. accounts for a significant percentage of energy expenditure, and of that energy use, a significant portion is due to aeration requirements of aerobic organisms consuming ammonium (NH₄⁺—N) and organic carbon.

While anaerobic ammonia-oxidizing (anammox) bacteria have potential to reduce the energy demand due to aeration for nitrogen removal, their full practical application has not been realized due to low ammonium concentration, low water temperature, and the presence of inhibitory organic components. Similarly, anaerobic digestion (AD) converts organic material to methane (CH₄) with no requirement for air and an output of methane fuel, however, its practical application for mainstream wastewater processes has not been realized due to low organic strength and low temperature and also difficulties in recovery of CH₄.

In addition, the presence of organic matter in existing devices leads to the proliferation of heterotrophic bacteria, which compete with ammonia-oxidizing microorganisms (AOMs) for oxygen and anammox bacteria for nitrite. Organic matter also reduces abundance and activity of anammox bacteria and contributes to the fouling of anammox systems using membrane bioreactors (MBRs), or membrane aerated biofilm reactors (MABRs), resulting in increased costs associated with cleaning, repair, or replacement of membrane surfaces for continued operation. Organic matter-facilitated fouling of existing MBRs or MABRs represents a significant drawback of existing devices.

Furthermore, existing wastewater treatment devices typically produce large amounts of bacterial biosolids, which is costly to process and dispose of and is associated with further complexities. For example, the biosolids can be dewatered and transported to a location for use as fertilizer, or concentrated and moved into an anaerobic digester, however, this process produces ammonia, which must also be managed. Since wastewater contains human waste, the biosolids cannot be used in agriculture, so instead, it can be transported to remote areas where it is sprayed on the ground for absorption by the soil, where it becomes fertilizer for plants and trees. The transport and handling costs due to production of bacterial biosolids by existing wastewater treatment devices and plants is substantial, even in instances where the biosolids are transferred between reactors within a treatment site.

In addition, hydrogen gas is produced industrially either as a product or by-product of a wide range of activities. While hydrogen can be utilized for a variety of applications, including but not limited to transportation, synthetic fuels, and industrial processes, its widespread adoption has been limited due to difficulties encountered with storage and transport of this flammable and highly reactive gas. Economic and efficient conversion of hydrogen to a more stable form of chemical energy, such as methane, would enable widespread adoption of hydrogen as a precursor for methane production, which is more easily stored and transported and useful as a combustible or chemical.

Accordingly, there is a need for single-reactor, low aeration energy systems for combined nitrogen and carbon removal for bioremediation and water treatment that produces decreased levels of bacterial biosolids, as well as improved devices and systems for resource recovery and methane production utilizing hydrogen as an input. The present disclosure addresses these and other long-felt and unmet needs in the art.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect, the disclosure provides a hydrogel matrix configured for bioremediation by a process, the hydrogel matrix comprising: an aerobic ammonium oxidizer (AOO) selected from the group consisting of an ammonium oxidizing bacterium, an ammonium oxidizing archaeon, a complete ammonium oxidizing (comammox) bacterium, or any combination thereof; and an anaerobic ammonia oxidizing (Anammox) bacterium.

In embodiments, the Anammox bacterium is positioned toward an interior of the hydrogel matrix and the AOO is positioned toward an exterior of the hydrogel matrix.

In embodiments, the hydrogel matrix is configured as a hydrogel bead.

In an aspect, the disclosure provides a device for bioremediation, the device comprising a hydrogel matrix.

In embodiments, the device further comprises: an infrared light heat element, or radiative heat element, that is configured to irradiate carbon black that is encapsulated within the hydrogel matrix to warm the hydrogel matrix and facilitate the process.

In embodiments, with operation of the device, total nitrogen of an effluent of a bulk liquid of the device is decreased.

In embodiments, the device further comprises: a hollow fiber membrane, positioned within an interior of the device, that comprises an interior that is fluidly connectible with air and an exterior with a biofilm coating thereon that comprises, for a partial nitrification/anammox (PN/anammox) process, an Anammox bacterium, an ammonium-oxidizing archaea (AOA), an ammonium-oxidizing bacterium (AOB), a nitrite-oxidizing bacterium (NOB), a comammox bacterium, or any combination thereof.

In embodiments, the device further comprises a heat element configured to warm the hollow fiber membrane, the hydrogel matrix, a bulk liquid of the device, or any combination thereof to facilitate the PN/anammox process, the process, or both.

In an aspect, the disclosure provides a device for resource recovery, the device comprising: a hollow fiber membrane, positioned within an interior of the device, that comprises an interior that is fluidly connectible with CO₂ and H₂ gas and an exterior with a biofilm coating thereon that comprises, for a CH₄ production process, a hydrogenotrophic methanogen.

In embodiments, the hydrogenotrophic methanogen is disposed with a hydrogel coating that replaces or supplements extracellular polymeric substances (ESP) produced by the hydrogenotrophic methanogen and increases conversion of CO₂ and H₂ to CH₄ by the hydrogenotrophic methanogen.

In embodiments, the hydrogenotrophic methanogen comprises a species of Methanobacteria, a species of Ca. Methanofastidiosum, a species of Methanosaeta, a species of Methanolinea, or any combination thereof.

In embodiments, the device further comprises a CH₄ sensor positioned at a gas exhaust of the device for measurement of methane produced by the hydrogenotrophic methanogen of the device at the gas exhaust.

In embodiments, CH₄ produced by the hydrogenotrophic methanogen is used as an energy source for wastewater treatment, by a nitrate/nitrite dependent methane oxidizer for denitrification in a bulk liquid of the device, as an energy source for industrial use, as an energy source for consumer use, or any combination thereof.

In embodiments, CH₄ produced by the hydrogenotrophic methanogen is used as an energy source for a methanotroph utilizing oxygen from a bulk liquid, within the interior of the device, to produce CH₃OH, poly-ß-hydroxybutyrate (PHB), or both; the device optionally further comprising a nitrate/nitrite dependent methane oxidizer.

In an aspect, the disclosure provides a device for bioremediation or resource recovery, the device comprising: a hollow fiber membrane positioned within an interior of the device, wherein the hollow fiber membrane comprises an interior that is fluidly connectible with a gas and an exterior with a biofilm coating thereon that comprises a first microorganism, wherein the hollow fiber membrane is permeable to at least one molecule of the gas that is utilizable by the first microorganism for a first process that comprises an aerobic process; and a second microorganism positioned at an outer layer of the biofilm coating, within a bulk liquid that is in fluid contact with the biofilm coating, encapsulated within a hydrogel matrix within the bulk liquid, or any combination thereof, wherein the second microorganism is for a second process that comprises an anaerobic process.

In embodiments, with bioactivity of microorganisms on the hollow fiber membrane, an inner layer of the biofilm coating has a higher concentration of O₂ and an outer layer of the biofilm coating has a lower concentration of O₂.

In embodiments, the first process removes NH₄⁺, total inorganic nitrogen (TIN), or both from a bulk liquid of the interior of the device, wherein the bulk liquid is in fluid contact with the biofilm coating.

In embodiments, the first microorganism comprises an AOA, an AOB, a comammox, a NOB, or any combination thereof.

In embodiments, the AOA comprises a species of the Nitrososphaera genus or N. viennensis.

In embodiments, the NOB comprises Nitrospira defluvii, a different species of the Nitrospira genus, complete ammonium oxidizing bacteria (comammox), a species that is capable of complete ammonium oxidation via formation of nitrite as an intermediate, or any combination thereof.

In embodiments, the anaerobic process removes NH₄⁺, organics, or both from the bulk liquid.

In embodiments, the second microorganism comprises an anaerobic ammonium oxidation (Anammox) bacterium.

In embodiments, the Anammox bacterium comprises a species of Ca. Brocadia, a species of Ca. Kuenenia, a species of Ca. Scalindua, a species of Ca. Anammoxoglobus, a species of Ca. Jettenia, or any combination thereof.

In embodiments, the Anammox bacterium comprises a species of Ca. Brocadia.

In embodiments, the device further comprises a DO controller operably connected to a DO probe and an aeration valve for actuation of the aeration valve and adjustment of rate of aeration of the hollow fiber membrane based on a DO reading from the DO probe, such that the outer layer of the biofilm coating and the bulk liquid are maintained as at least mostly anaerobic for the anaerobic process.

In embodiments, actuation of the aeration valve and adjustment of rate of aeration of the hollow fiber membrane are performed manually by an operator or automatically by the DO controller.

In embodiments, the device further comprises an influent pump fluidly connected to the interior of the device and configured to pump wastewater into the interior of the device.

In embodiments, the device further comprises a mechanical mixer or a mixing gas inlet fluidly connected to the interior of the device and configured to deliver N₂ gas into the interior of the device.

In embodiments, the device is operational within a wide temperature range, is deployable to cold climates, and produces a decreased bacterial biosolid mass compared to a previous device.

In embodiments, the wide temperature range includes the range of 10-25° C., or a portion thereof.

In embodiments, the second microorganism comprises an Anammox bacterium.

In embodiments, the device further comprises: a third microorganism, either as at least part of an anaerobic digester sludge or as an acetogenic methanogen, that is encapsulated within a hydrogel matrix within the bulk liquid; wherein the third microorganism is for an anaerobic process that removes carbon from the bulk liquid and prevents biofouling of the device by a heterotroph.

In an aspect, the disclosure provides a method for bioremediation, the method comprising: contacting a bulk liquid with a hollow fiber membrane that comprises an interior that is fluidly connectible with air and an exterior with a biofilm coating thereon that comprises a first microorganism that comprises a comammox, an AOA, an AOB, a NOB, or any combination thereof; wherein the hollow fiber membrane is permeable to O₂ of the air that is utilizable by the first microorganism for a first process that comprises an aerobic process.

In embodiments, the AOA comprises a species of the Nitrososphaera genus or N. viennensis.

In embodiments, the NOB comprises Nitrospira defluvii, a different species of the Nitrospira genus, complete ammonium oxidizing bacteria (comammox), a species that is capable of complete ammonium oxidation via formation of nitrite as an intermediate, or any combination thereof.

In embodiments, the method further comprises: contacting the bulk liquid with a hydrogel matrix comprising an Anammox bacterium, an AOO, or both for an anaerobic process.

In embodiments, the hydrogel matrix comprises the Anammox bacterium and the AOO, wherein the Anammox bacterium is positioned toward an interior of the hydrogel matrix and the AOO bacterium is positioned toward an exterior of the hydrogel matrix.

In embodiments, the method further comprises: contacting the bulk liquid with a hydrogel matrix comprising a third microorganism, either as at least part of an anaerobic digester sludge or as an acetogenic methanogen, that is encapsulated within the hydrogel matrix within the bulk liquid: wherein the third microorganism is for an anaerobic process that removes carbon from the bulk liquid and prevents biofouling of the device by a heterotroph.

In embodiments, the method further comprises: monitoring the bulk liquid for DO, pH, and influent/effluent NH₄⁺—N, NO₂⁻—N and NO₃⁻—N concentrations; and aerating the interior of the hollow fiber membrane with air based on real-time ammonium loading and oxygen demand of microorganisms.

In embodiments, the method is configured to be performed within a wide temperature range and produces a decreased bacterial biosolid mass compared to a previous device.

In embodiments, the wide temperature range includes the range of 10-25° C., or a portion thereof.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings.

FIG. 1A shows an example schematic design of a membrane-hydrogel bioreactor with a combination of biofilm on membrane and hydrogel beads in the bulk liquid; FIG. 1B shows oxygen conditions in the biofilm and bulk liquid of the membrane-hydrogel reactor; and FIG. 1C shows an example schematic design of a technology with hydrogel beads in the bulk liquid, and infrared heat elements, according to aspects of the disclosure.

FIG. 2A shows an example membrane bioreactor including a membrane coated with a methanogen biofilm for biomethanization of CO₂ and H₂, and FIG. 2B shows an example of diffusion and concentration gradient of CO₂ and H₂ along the biofilm, according to aspects of the disclosure.

FIGS. 3A and 3C show concentrations of sCOD in the influent and effluent under aerobic (FIG. 3A) and anaerobic (FIG. 3C) conditions; FIG. 3B shows changes in membrane fibers in an example reactor without hydrogel capsulated anaerobic digestion sludge and fouling; and FIG. 3D shows an example hydrogel-membrane reactor with hydrogel capsulated anaerobic digestion sludge, according to aspects of the disclosure.

FIG. 4A shows concentrations of NH₄⁺—N, NO₂⁻—N, and NO₃⁻—N in the influent and effluent, and FIG. 4B shows removal efficiency of NH₄⁺—N and total inorganic nitrogen (TIN) of an example membrane-hydrogel reactor during operation at 25° C., 16° C. and 10° C. according to aspects of the disclosure.

FIG. 5A shows dynamics of NH₄⁺—N, FIG. 5B shows dynamics of NO₃⁻—N N/NO₂⁻—N, FIG. 5C shows dynamics of total inorganic nitrogen (TIN), and FIG. 5D shows specific reaction rate of NH₄⁺—N and TIN in an example membrane reactor, according to aspects of the disclosure. *Nitrate residual in the reactor before batch tests were subtracted from results of FIG. 5B, while no detectable residual of NH₄⁺—N or NO₂⁻—N N was observed in the reactor before batch tests.

FIG. 6 shows non-metric multidimensional scaling (NMDS) analysis of the amplicon sequencing variants of 16S rRNA sequencing of biofilm and hydrogel encapsulated anaerobic digestion sludge and primary effluent, according to aspects of the disclosure.

FIG. 7A shows abundance of mcrA genes of methanogen measured by qPCR and FIG. 7B shows genus information and abundance (log 10 transformed, unitless) of methanogens measured by 16S sequencing in an example hydrogel encapsulated anaerobic digestion sludge, according to aspects of the disclosure.

FIG. 8A shows abundances of marker genes of anammox (16S), AOA (amoA), AOB (amoA), and NOB (nxrB) in an example biofilm as measured by qPCR, and FIG. 8B shows genus and relative abundance (log 10 transformed, unitless) of nitrogen converting microorganisms in the example biofilm and primary effluent of WWTP (PE) as measured by 16S sequencing, according to aspects of the disclosure.

FIG. 9A shows concentrations of NH₄⁺—N, NO₂⁻—N, and NO₃⁻—N in the influent and effluent and FIG. 9B shows removal efficiency of NH₄⁺—N and total inorganic nitrogen (TIN) of the membrane reactor during operation, according to aspects of the disclosure.

FIG. 10 shows NH₄⁺—N and TIN removal in a failed AOA-anammox membrane reactor, without hydrogel beads of anaerobic digester sludge, according to aspects of the disclosure.

FIG. 11 shows VSS/TSS in the influent and effluent of the membrane reactor during pilot operation, according to aspects of the disclosure.

FIG. 12A shows concentrations of nitrogen species, and FIG. 12B shows soluble chemical oxygen demands (sCOD), in the influent and effluent of an example membrane-hydrogel reactor, according to aspects of the disclosure.

FIG. 13 shows an example of instantaneous functioning of a coated membrane, according to aspects of the disclosure. Data was collected with a membrane coated with other biomass (not methanogen) following an example membrane coating procedure as disclosed herein.

FIG. 14 shows an example schematic design of a hydrogel bioreactor with hydrogel beads in the bulk liquid and an example control/monitoring system; in the shown example, hydrogel beads include encapsulated anammox sludge, a pure culture of comammox, and carbon black powder to enhance absorbance of radiation, according to aspects of the disclosure.

FIG. 15A shows concentrations of nitrogen species in the influent and effluent of the example bioreactor of FIG. 14; FIG. 15B shows nitrogen removal efficiency; and FIG. 15C shows ΔCOD/ΔTIN of the reactor fed with synthetic media containing no COD, according to aspects of the disclosure.

FIG. 15D shows concentrations of nitrogen species in the influent and effluent of the example bioreactor of FIG. 14; FIG. 15E shows nitrogen removal efficiency; and FIG. 15F shows ΔCOD/ΔTIN of the reactor fed with actual wastewater, according to aspects of the disclosure.

FIG. 16A and FIG. 16B show reduction rate of NH₄⁺—N and total inorganic nitrogen (TIN) in an example bioreactor with hydrogel encapsulated Comammox and Anammox biomass at 4° C. 10° C., 16° C., 25° C. and Radiation, according to aspects of the disclosure. Under the Radiation condition, the temperature was 4° C. for the influent and 5° C. for the bulk liquid in the reactor.

FIG. 17A shows example abundances of Comammox (amoA), Anammox (16S rRNA) in the reactor as measured by qPCR. FIG. 17B and FIG. 17C show FISH images showing the growth of nxrB of Nitrospira (Cy3 channel shown in FIG. 17B) and Anammox (FITC channel shown in FIG. 17C) within the entire hydrogel bead and near the edge of the hydrogel bead, according to aspects of the disclosure. Beads in this figure were sampled on Day 203.

FIG. 18 shows an example heatmap and relative abundances (log 10 transformed) of the top 30 genera in the hydrogel beads during operation with synthetic media or actual wastewater at 25° C., 16° C., 10° C., 4° C., and Radiation conditions from day 0 to day 206, as well as the reactor influent which is the primary effluent (PE) of a municipal wastewater treatment plant, according to aspects of the disclosure. The temperature of bulk liquid in the reactor at Radiation was 5° C., while the influent temperature was 4° C. ND is not detected.

FIG. 19A shows steps of an example method of making a bioreactor comprising a hollow fiber membrane with a biomass coating thereon, and FIG. 19B shows steps of an example method of making a bioreactor for anaerobic digestion with hydrogel beads, according to aspects of the disclosure.

FIG. 20 shows an example method of monitoring a bioreactor and adjusting aeration of the bioreactor to ensure adequate oxygen supply to aerobic processes and adequate anaerobic conditions for anaerobic processes.

### DETAILED DESCRIPTION

The disclosure provides improved compositions, devices, and methods for bioremediation and wastewater treatment that combine different processes having different growth and reaction requirements into a single bioreactor that includes different niches that enable the different processes to coexist for continuous operation. The disclosed approaches significantly lower the work and energy required for aeration of water treatment systems and can be deployed to a wider range of climates, including colder climates, enabling effective water treatment year-round. In addition, the disclosed devices are capable of simultaneously removing both carbon and nitrogen from bulk liquid while also eliminating fouling of the MABR membrane surface and extending the useful life of the MABR membrane surfaces, reducing costs. The disclosed devices also produce less bacterial biosolid mass compared to previous devices, and in at least some instances including with reference to Anammox, the disclosed devices are able to reduce the amount of bacterial biosolids produced by 75% compared to previous devices. In addition, disclosed devices can be utilized with CO₂ and H₂, for example, as can be exhausted from a concentrated industrial off gas or from electrolysis (in the case of H₂) for resource recovery and methane production. For the latter, concentrated H₂ can be cofed into a bioreactor digester of the disclosure to convert excess CO₂ to methane, enabling 100% methane to be produced.

### Wastewater Treatment Devices and Methods

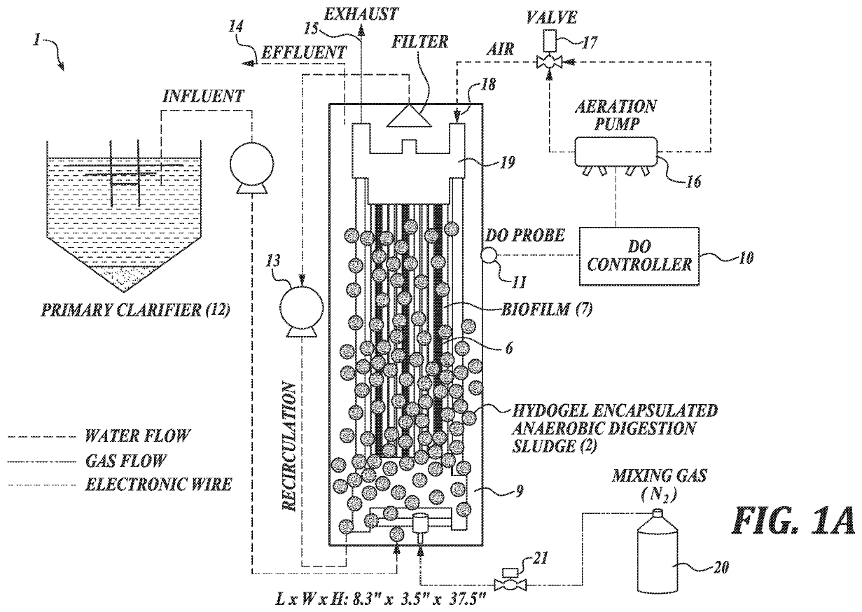

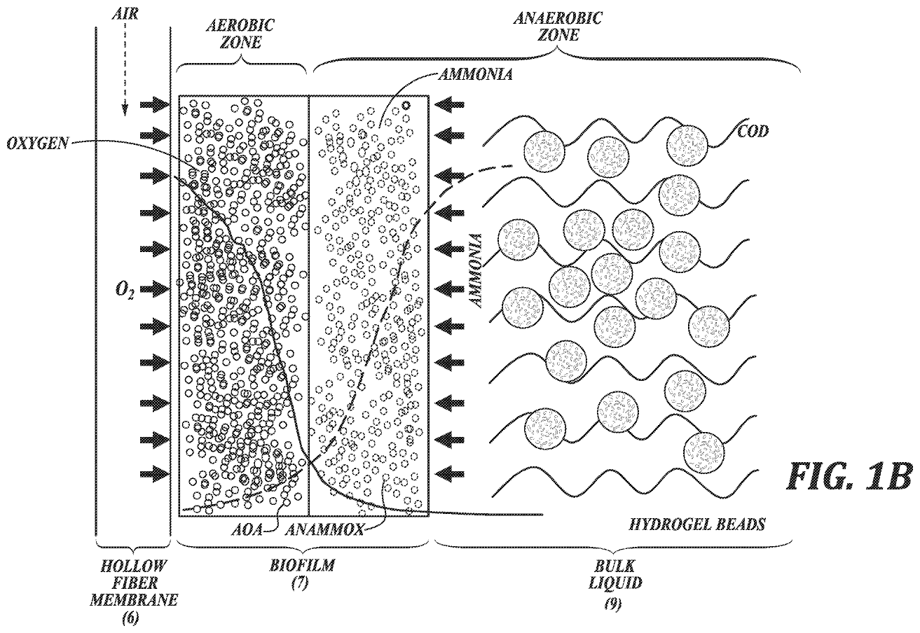

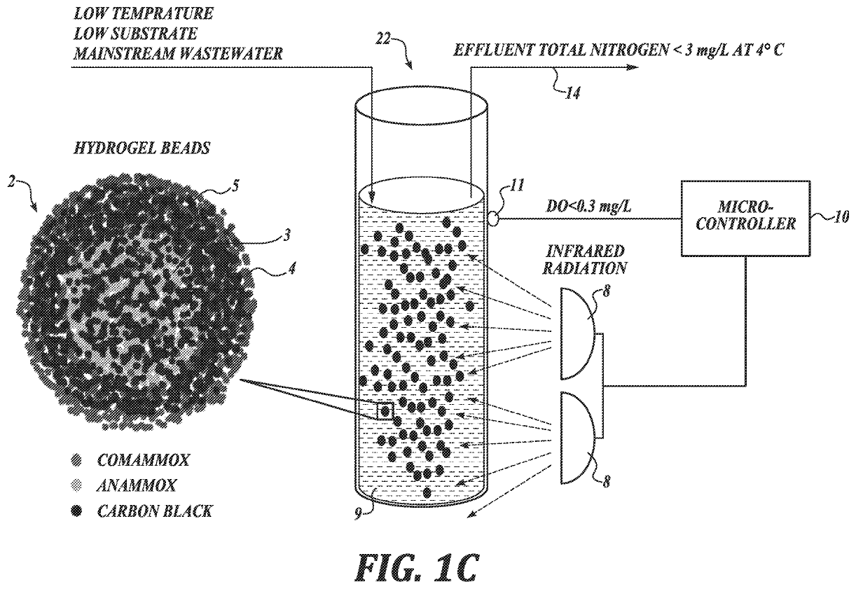

In an aspect, and as shown by way of example at FIG. 1C, the disclosure provides a hydrogel matrix, optionally configured as a hydrogel bead 2, that comprises an Anammox bacterium 4, an AOO 3, or both (3, 4), for one or more processes for bioremediation, treatment of water, treatment of main line wastewater, or any combination thereof. Example processes include anaerobic, microaerophilic, and aerobic processes as can be carried out by one or more microorganisms of the hydrogel bead 2. Since warmth can facilitate bioprocesses, but heating of bulk liquids can be costly, in at least some embodiments, the hydrogel matrix can further include a composition that has a particular radiation absorption spectrum compared to bulk liquid or other components of a bioreactor of the disclosure, such that radiation of one or more particular frequencies is selectively absorbed by the composition to produce thermal energy. In example embodiments, such a composition can include carbon black 5, which can absorb infrared radiation from a light source, e.g., an infrared light source, to selectively warm the hydrogel matrix and bacteria and facilitate the anaerobic process, even at colder temperatures and climates. As a result of this and other features of the disclosure, the bioreactor can be effectively active at wider temperature ranges compared to previous iterations. While carbon black 5 is implemented in the shown embodiment, compositions or substances other than carbon black 5 can be implemented in at least some embodiments, for selective radiation absorption and warmth of the hydrogel bead and microorganisms, without departing from the scope and spirit of the disclosure.

In embodiments, the hydrogel matrix comprises the Anammox bacterium and the AOO (which can include, for example, an ammonium oxidizing bacterium, an ammonium oxidizing archaeon, a comammox bacterium, or any combination thereof), and the Anammox bacterium is positioned toward an interior of the hydrogel matrix and the AOO is positioned toward an exterior of the hydrogel matrix, as can occur as a result of different niche requirements. For example. Anammox can be more abundant in the low-oxygen inner core while the AOO can be more abundant in the oxygenated periphery of the hydrogel beads.

In another aspect, the disclosure provides devices configured for one or more water treatment processes (which can include, for example, a microaerophilic process, an aerobic process, an anaerobic process, or any combination thereof), for industrial off-gas processing and/or methane production or resource recovery, and wastewater treatment. A combination aerobic-anaerobic device 1, shown at FIG. 1A and with corresponding aerobic and anaerobic zones shown at FIG. 1B, is configured for water treatment. The device 1 includes a hydrogel matrix 2 with encapsulated anaerobic digestion sludge (includes anaerobic microorganisms), as well as a hollow fiber membrane 6, positioned within an interior of the device 1, with a biofilm coating 7 on an exterior portion thereof. An interior of the hollow fiber membrane 6 is fluidly connectible with air provided by an aeration pump 16, which in the shown example is controllable by actuation of valve 17. Administration of air into the interior of the hollow fiber membrane 6, by way of connection 18, can be implemented by passage of the air through conduit 19, which fluidly connects connection 18 with hollow fiber membrane 6. Once inside the hollow fiber membrane 6, air (or oxygen of the air) can diffuse through the membrane to the biofilm, such that the oxygen is accessible to microorganisms of the biofilm coating 7 for an aerobic process. In example embodiments, the biofilm coating 7 can comprise, for a partial nitrification/anammox (PN/anammox) process, an Anammox bacterium, an ammonium-oxidizing archaea (AOA), an ammonium-oxidizing bacterium (AOB), a nitrite-oxidizing bacterium (NOB), a comammox bacterium, or any combination thereof. In embodiments, the hydrogel matrix 2 is disposed in a bulk liquid 9 of the interior of the device 1.

During operation of device 1, wastewater is pumped, e.g., from a primary clarifier 12, into the bulk liquid 9 of the device 1. A dynamic portion of bulk liquid 9 can be recirculated, e.g., via pump 13, for repeated processing. Effluent 14 passes from the device 1 and can include a lower level of nitrogen, carbon, or both. In example embodiments, concentration of total nitrogen of an effluent of a bulk liquid of the device is less than 3 mg/L, including with operation of the device 1 at lower temperatures. Exhaust 15 passes from the device 1 and can be passed into an environment, stored, or utilized or further processed. In the shown embodiment, the aeration pump 16 can be operably connected to a dissolvable oxygen (DO) controller, which can be configured for conditional actuation of valve 17, as a result of a signal received from a DO probe placed in and configured to detect DO levels in the bulk liquid 9, for controlled aeration of the device 1, such that aerobic microorganisms are maintained in an aerobic niche and anaerobic microorganisms are maintained in an anaerobic niche. In the shown embodiment, mixing gas (e.g., N₂) is delivered from a mixing gas source 20 to the bulk liquid 9 by way of a mixing gas valve 21, for effective mixture of the bulk liquid 9 during operation, however, alternate embodiments can include mechanical mixers, alone or in combination with a mixing gas, for cost-effectively mixing larger volumes at scale.

As shown by way of example at FIG. 1C, in at least some embodiments, a device 22 can be configured for an anaerobic process without necessarily being configured for an aerobic process. The shown example device 22, as well as other embodiments of devices of the disclosure, can include an infrared (IR) light heat element 8, e.g., an IR light-emitting diode (LED), that is configured to irradiate carbon black that is encapsulated within the hydrogel matrix 2 to warm the hydrogel matrix 2 and thereby facilitate the anaerobic process. In this manner, the device 22, and other embodiments of devices of the disclosure, can be operable at lower temperatures. In the shown example, a DO probe 11 can be used to measure DO in the bulk liquid 9, and a micro controller 10 that receives signals from the DO probe 11 can be used to conditionally activate the IR light heat element 8 to activate or facilitate the anaerobic process, for example, if the DO level measured by the probe is below a threshold value. In example embodiments, a threshold value for DO can be 0.3 mg/L, however, other threshold values can be implemented in embodiments. By facilitating the anaerobic process under low DO conditions, the anaerobic microorganisms and processes of the hydrogel matrix 2 can be effectively maintained.

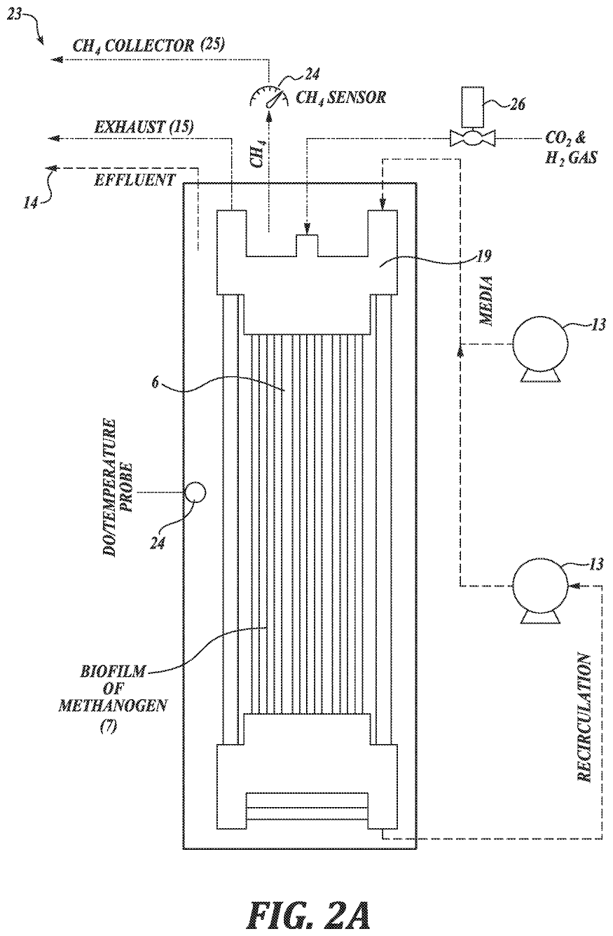

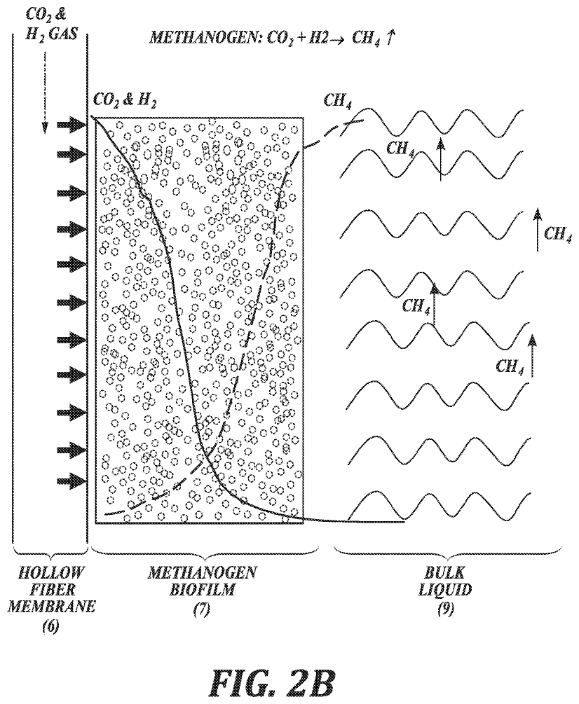

As shown by way of example at FIG. 2A, there is shown a device 23 for resource recovery or methane production, the device 23 comprising a hollow fiber membrane 6, positioned within an interior of the device 23, that comprises an interior that is fluidly connectible with CO₂ and H₂ gas (e.g., by way of valve 26) and an exterior with a biofilm 7 thereon that comprises, for a CH₄ production process, a methanogen. The methanogen can be disposed, on the exterior of the hollow fiber membrane 6, with a hydrogel coating that replaces or supplements extracellular polymeric substances (ESP) produced by the methanogen and increases conversion of CO₂ and H₂ to CH₄ by the methanogen.

During operation, methanogen culture media can be introduced to the bulk liquid, and dynamic portions of the media and bulk liquid recirculated through the system for repeated use by the methanogens, for example, via pump(s) 13. Gas inputs to the device 23, CO₂ and H₂, can be delivered to the interior of the hollow fiber membrane 6 by way of valve 26, which can be conditionally activated for improved or optimal bioactivity, e.g., as a result of DO and/or temperature readings from DO/temperature probe 24. DO/temperature probe can be operably connected to a controller, which can comprise circuitry for conditional activation of valve 26 based on the DO/temperature readings. The anaerobic process of the methanogens produces CH₄, which can be detected with a CH₄ sensor 24 and collected by a CH₄ collector 25.

As shown by way of example at FIG. 2B, the biofilm 7 of the device 23 of FIG. 2A comprises methanogens that process CO₂ and H₂ that diffuse from the interior of the hollow fiber membrane 6. As the activity of the methanogens proceeds. CO₂ and H₂ levels drop off and CH₄ levels increase, further from the biofilm 7, in the bulk liquid 9. In embodiments, the methanogen of the biofilm 7 comprises a species of Methanobacteria, a species of Ca. Methanofastidiosum, a species of Methanosaeta, a species of Methanolinea, or any combination thereof. Since the H₂ is effectively converted to CH₄, the methane produced by the methanogens can be used as an energy source. Non-limiting examples of uses for methane produced include wastewater treatment, use by a nitrate/nitrite dependent methane oxidizer for denitrification in a bulk liquid of the device, use as an energy source for industry, use as an energy source for consumer use, or any combination thereof.

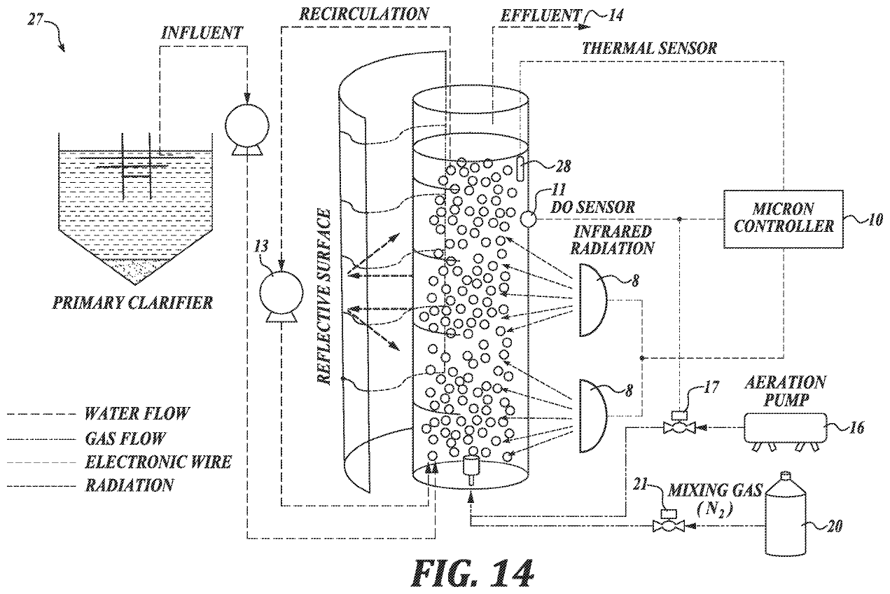

FIG. 14 shows another example embodiment of a device 27, which is configured for at least an anaerobic process and, optionally, an aerobic process. The device 27 includes, in addition to an IR light element 8, a reflective surface configured to reflect at least a portion of IR light emitted from the IR light element 8 back to the interior of the device 27 to increase irradiation of hydrogel matrices of the bulk liquid, heating of carbon black of the hydrogel matrices, and facilitation of one or more processes of microorganisms of the hydrogel matrices, including anaerobic processes, aerobic processes, or both.

During operation of device 27, wastewater is pumped, e.g., from a primary clarifier, into the bulk liquid of the device 27. A dynamic portion of bulk liquid can be recirculated, e.g., via pump 13, for repeated processing. Effluent 14 passes from the device 27 and can include a lower level of nitrogen, carbon, or both. In example embodiments, concentration of total nitrogen of an effluent of a bulk liquid of the device is less than 3 mg/L, including with operation of the device 27 at lower temperatures. In the shown embodiment, the aeration pump 16 can be operably connected to a micro controller 10, which can be configured for conditional actuation of valve 17 and/or conditional activation of IR light heat element 8, as a result of a signal received from a DO probe 11 placed in and configured to detect DO levels in the bulk liquid, for controlled aeration of the device 27, such that aerobic microorganisms are maintained in an aerobic niche and anaerobic microorganisms are maintained in an anaerobic niche. Similarly, the IR light heat element 8 can be operably connected to the micro controller 10, which can be configured for conditional activation of IR light heat element 8, as a result of a signal received from a thermal sensor 28 configured to detect temperature of the bulk liquid. In the shown embodiment, mixing gas (e.g., N₂) is delivered from a mixing gas source 20 to the bulk liquid by way of a mixing gas valve 21, for effective mixture of the bulk liquid during operation, however, one or more mechanical mixing apparatuses or systems can be implemented, either alone or in combination with mixing gas for mixing larger volumes at scale.

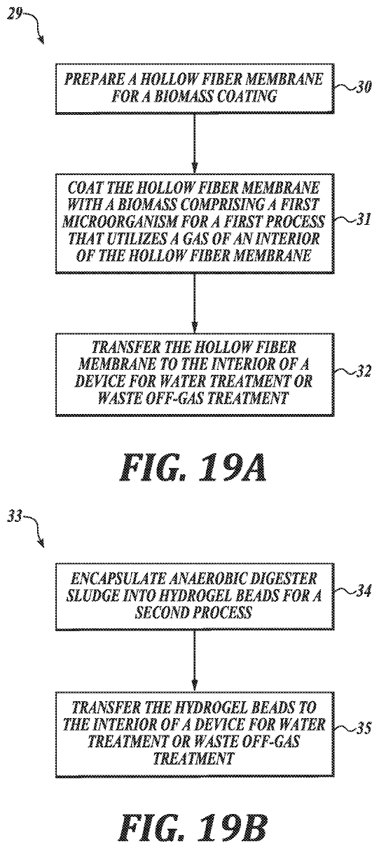

As shown at FIG. 19A, an example method 29 of making a bioreactor that comprises a hollow fiber membrane with a biomass coating thereon can comprise several steps. At step 30, a hollow fiber membrane is prepared for a biomass coating. At step 31, the hollow fiber membrane is coated with the biomass, wherein the biomass comprises a first microorganism for a first process that utilizes a gas of an interior of the hollow fiber membrane. At step 32, the hollow fiber membrane (with the biomass thereon) is transferred to the interior of a device for water treatment or waste off-gas treatment, for example.

As shown at FIG. 19B, an example method 33 of making a bioreactor for anaerobic digestion with hydrogel beads can comprise several steps. At step 34, an anaerobic digester sludge is encapsulated into hydrogel beads for a second (e.g., anaerobic) process. At step 35, the hydrogel beads (with the anaerobic digester sludge encapsulated therein) are transferred to the interior of a device for water treatment or waste off-gas treatment.

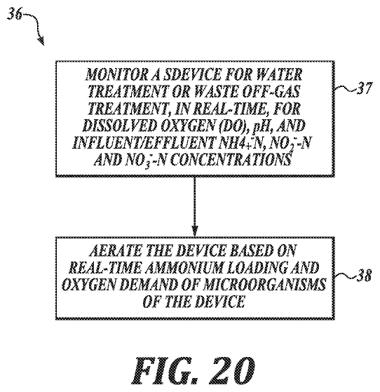

As shown at FIG. 20, an example method 36 of monitoring a bioreactor and adjusting aeration of the bioreactor to ensure adequate oxygen supply to aerobic processes and adequate anaerobic conditions for anaerobic processes can comprise several steps. At step 37, a device is monitored for water treatment or waste off-gas treatment, in real-time, for dissolved oxygen (DO), pH, and influent/effluent NH₄⁺—N, NO₂⁻—N, and NO₃⁻—N concentrations. At step 38, the device is aerated based on real-time ammonium loading and oxygen demand of microorganisms of the device.

In another aspect, the disclosure provides a method for bioremediation or water treatment. The method comprises: contacting a bulk liquid with a hollow fiber membrane that comprises an interior that is fluidly connectible with air and an exterior with a biofilm thereon that comprises a first microorganism that comprises an AOA, an AOB, a NOB, or any combination thereof. The hollow fiber membrane is permeable to O₂ of the air that is utilizable by the first microorganism for a first process that comprises an aerobic process. In embodiments, the method further comprises: contacting the bulk liquid with a hydrogel matrix comprising an Anammox bacterium, a comammox bacterium, or both for an anaerobic process. These and equivalent methods of the disclosure can be performed by one or more compositions and/or devices, or equivalent compositions and/or devices, of the disclosure.

### Circuitry, Processor, and Computer Implementations

Embodiments of devices and any systems disclosed herein, including embodiments that include or utilize a controller (e.g., micro controller, DO controller), a processor, and/or processor executable instructions, can utilize circuitry to implement those technologies and methodologies. Such circuitry can operatively connect two or more components, generate information, determine operation conditions, control an appliance, device, or method, and/or the like. Circuitry of any type can be used. In embodiments, circuitry includes dedicated hardware having electronic circuitry configured to perform operations or computations on a dedicated basis, without any use of microprocessors, central processing units, or software or firmware or processor-executable instructions. However, in embodiments, circuitry includes, among other things, one or more computing devices such as one or more processors (e.g., microprocessor(s)), one or more central processing units (CPU), one or more digital signal processors (DSP), one or more application-specific integrated circuits (ASIC), one or more field-programmable gate arrays (FPGA), or the like, or any variations or combinations thereof, and can include discrete digital and/or analog circuit elements or electronics, or combinations thereof.

In embodiments, circuitry includes one or more ASICs having a plurality of predefined logic components. In embodiments, circuitry includes one or more FPGA having a plurality of programmable logic components. In embodiments, circuitry includes hardware circuit implementations (e.g., implementations in analog circuitry, implementations in digital circuitry, and the like, and combinations thereof). In embodiments, circuitry includes combinations of circuits and computer program products having software or firmware processor-executable instructions stored on one or more computer readable memories, e.g., non-transitory computer-readable storage mediums, that work together to cause a device or system to perform one or more methodologies or technologies described herein.

In embodiments, circuitry includes circuits, such as, for example, microprocessors or portions of microprocessors, that require software, firmware, and the like for operation. In embodiments, circuitry includes an implementation comprising one or more processors or portions thereof and accompanying software, firmware, hardware, and the like. In embodiments, circuitry includes a baseband integrated circuit or applications processor integrated circuit or a similar integrated circuit in a server, a cellular network device, other network device, or other computing device. In embodiments, circuitry includes one or more remotely located components. In embodiments, remotely located components (e.g., server, server cluster, server farm, virtual private network, etc.) are operatively connected via wired and/or wireless communication to non-remotely located components (e.g., desktop computer, workstation, mobile device, controller, etc.). In embodiments, remotely located components are operatively connected via one or more receivers, transmitters, transceivers, or the like.

Embodiments include one or more data stores that, for example, store instructions and/or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In embodiments, circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In embodiments, circuitry includes one or more user input/output components that are operatively connected to at least one computing device to control (electrical, electromechanical, software-implemented, firmware-implemented, or other control, or combinations thereof) one or more aspects of the embodiment.

In embodiments, circuitry includes a computer-readable media drive or memory slot configured to accept signal-bearing medium (e.g., computer-readable memory media, computer-readable recording media, or the like). In embodiments, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM. ROM, system memory, web server, or the like.

### Terminology

The description set forth herein in connection with the appended drawings, where like numerals may reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein can be interchangeable with other steps, or combinations of steps, in any suitable combination and/or order to achieve the same or substantially similar result. Generally, the embodiments disclosed herein are non-limiting, and the inventors contemplate that other embodiments within the scope of this disclosure can include structures and functionalities from more than one specific embodiment shown in the figures and described in the specification.

In the foregoing description, specific details are set forth to provide a thorough understanding of example embodiments of the present disclosure. It will be apparent to one skilled in the art, however, that the embodiments disclosed herein can be practiced without embodying all the specific details. In some instances, well-known process steps have not been described in detail in order not to unnecessarily obscure various aspects of the present disclosure. Further, it will be appreciated that embodiments of the present disclosure can employ any combination of features described herein and/or alternatives thereof.

As used herein, the terms “fluid” and “fluidly”, when used to refer to connections of certain structures such as channels, conduits, connections, and the like, refer to the property of such elements being in fluid or fluidic communication with each other, whether directly or indirectly, such that a fluid (e.g., a liquid or a gas), can flow from one such element to another such element via one or more connections therebetween.

The present application can include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application can also reference quantities and numbers. Unless specifically stated, such quantities and numbers are not to be considered restrictive, but examples of the possible quantities or numbers associated with the present application. Also in this regard, the present application can use the term “plurality” to reference a quantity or number. In this regard, the term “plurality” is meant to be any number that is more than one, for example, two, three, four, five, etc. The term “about,” “approximately,” “near,” etc., includes the stated value as well as non-stated values that are near to or approximate the stated value according to practicable ranges as would be recognized by those skilled in the art. The term “based on” means “based at least partially on.”

For the purposes of the present disclosure, the phrase “at least one of A, B, and C,” means (A), (B), (C), (A and B), (A and C), (B and C), or (A, B, and C), including all further possible permutations when greater than three elements are listed. Likewise, as used herein, the term “A, B, and/or C” means (A), (B), (C), (A and B), (A and C). (B and C), or (A, B, and C), including all further possible permutations when greater than three elements are listed. Unless otherwise stated, the term “or” is an inclusive “or”, and the phrase “A or B” means (A), (B), or (A and B). Unless otherwise stated, the term “and” requires both elements; for example, the phrase “A and B” means (A and B).

In the claims and for purposes of the present disclosure, the terms “a”, “an”, “the”, and the like, refer to the singular and the plural forms of the object or element referenced. In addition, the terms “comprising,” “comprises,” “comprise,” and the like, are open ended and do not exclude any additional features, elements, materials, or steps from those recited or described.

### Tables

TABLE 1
Sequences, amplicon sizes, annealing temperature, and
amplification efficiencies of the primers.

| | | | | | | | Ampli- |
|---|---|---|---|---|---|---|---|
| | | | | | Amp- | Ann- | fication |
| | | | | | licon | ealing | eff- |
| Target | Target | Primer | Forward primer | Reverse primer | size | Temp. | iciency |
| strains | gene | name | 5′-3′ | 3′-5′ | (bp) | (° C.) | (R²) |
| Universal | Total | 515F- | GTGYCAGCMG | CCGYCAATTY | 412 | 50 | 99.7% |
| 16S | microbial | Y/926R | CCGCGGTAA | MTTTRAGTTT | | | (1.00) |
| | 16S | | (SEQ ID NO: 1) | (SEQ ID NO: 2) | | | |
| | rRNA | | | | | | |
| Anammox | Anammox | 818F/ | ATGGGCACTMR | CAGCCATGCAA | 223 | 60 | 103.4% |
| | 16S | 1040R | GTAGAGGGGTT | CACCTGTRATA | | | (1.00) |
| | rRNA | | T | (SEQ ID NO: 4) | | | |
| | | | (SEQ ID NO: 3) | | | | |
| AOB | AOB | amoA-1F | GGGGTTTCTAC | CCCCTCKGSAA | 491 | 60 | 100.9% |
| | amoA | (332- | TGGTGGT (SEQ | AGCCTTCTTC | | | (1.00) |
| | | 349)/2R | ID NO: 5) | (SEQ ID NO: 6) | | | |
| | | (802- | | | | | |
| | | 822) | | | | | |
| AOA | ACA | GenAOAF/ | ATAGAGCCTCA | CCAAGCGGCCA | 125 | 55 | 100.5% |
| | amoA | GenAOAR | AGTAGGAAAGT | TCCAGCTGTAT | | | (1.00) |
| | | | TCTA (SEQ ID | GTCC (SEQ ID | | | |
| | | | NO: 7) | NO: 8) | | | |
| NOB | NOB | nxrB169F/ | TACATGTGGTG | CGGTTCTGGTC | 470 | 56.2 | 97.2% |
| | nxrB | nxrB638R | GAACA (SEQ ID | RATCA (SEQ ID | | | (1.00) |
| | | | NO: 9) | NO: 10) | | | |
| Comammox | Ca. | Ino- | TCACCTTGTTG | TCCGCGTGAGC | 406 | 64 | 104.4% |
| | Nitro- | pinata | CTAACTAGAAA | CAATGT (SEQ | | | (0.99) |
| | spira | amoA- | CTGG (SEQ ID | ID NO: 12) | | | |
| | inopinata | 410F/ | NO: 11) | | | | |
| | amoA | 815R | | | | | |
| Methanogen | mcrA | mlas/ | GGTGGTGTMGG | CGTTCATBGCG | | 55 | 99% |
| | | mcrA- | DTTCACMCART | TAGTTVGGRTA | | | (0.99) |
| | | rev | A (SEQ ID | GT (SEQ ID | | | |
| | | | NO: 13) | NO: 14) | | | |

TABLE 2
Detailed information of samples
subjected to 16S rRNA sequencing.

| Day | Sample-type | Temperature | Sampling day |
|---|---|---|---|
| B-S | Membrane biofilm | Startup 25° C. | Startup |
| B9 | Membrane biofilm | Startup 25° C. | 9 day of pilot |
| | | | operation |
| B20 | Membrane biofilm | 25° C. | 20 day of pilot |
| | | | operation |
| B76 | Membrane biofilm | End of 25° C. and | 76 day of pilot |
| | | start of 16° C. | operation |
| B121 | Membrane biofilm | End of 16° C. and | 121 day of pilot |
| | | start of 10° C. | operation |
| B145 | Membrane biofilm | 10° C. | 145 day of pilot |
| | | | operation |
| D0 | Hydrogel | Start | 0 day of pilot |
| | encapsulated | | operation |
| | digestion sludge | | |
| D9 | Hydrogel | Start of pilot 25° C. | 9 day of pilot |
| | encapsulated | | operation |
| | digestion sludge | | |
| D20 | Hydrogel | 25° C. | 20 day of pilot |
| | encapsulated | | operation |
| | digestion sludge | | |
| D76 | Hydrogel | End of 25° C. | 76 day of pilot |
| | encapsulated | | operation |
| | digestion sludge | | |
| D121 | Hydrogel | End of 16° C. | 121 day of pilot |
| | encapsulated | | operation |
| | digestion sludge | | |
| D145 | Hydrogel | End of 10° C. | 145 day of pilot |
| | encapsulated | | operation |
| | digestion sludge | | |
| PE1 | Primary effluent | Wastewater | |
| PE2 | Primary effluent | Wastewater | |
| PE3 | Primary effluent | Wastewater | |

### EXAMPLES

### Example 1. Simultaneous Anaerobic Carbon and Nitrogen Removal from Primary Municipal Wastewater with Hydrogel Encapsulated Anaerobic Digestion Sludge and AOA-Anammox Coated Hollow Fiber Membrane

Abstract: In this example, a one-stage continuous-flow membrane-hydrogel reactor integrating both partial nitritation-anammox (PN-anammox) and anaerobic digestion (AD) was designed and operated for simultaneous autotrophic nitrogen (N) and anaerobic carbon (C) removal from mainstream municipal wastewater. In the reactor, a synthetic biofilm including anammox biomass and pure culture ammonia oxidizing archaea (AOA) were coated onto and maintained on a counter-diffusion hollow fiber membrane to autotrophically remove nitrogen. Anaerobic digestion sludge was encapsulated in hydrogel beads and placed in the reactor to anaerobically remove COD. During operation at three operating temperatures (25, 16, and 10° C.), the membrane-hydrogel reactor demonstrated stable anaerobic COD removal (76.2±15.5%) and membrane fouling was successfully suppressed allowing a stable PN-anammox process. The reactor demonstrated good nitrogen removal efficiency, with an overall removal efficiency of 95.8±5.0% for NH₄⁺—N and 78.9±13.2% for total inorganic nitrogen (TIN) during the entire pilot operation. Reducing the temperature to 10° C. caused a temporary reduction in nitrogen removal performance and abundances of AOA and anammox. However, the reactor and microbes demonstrated the ability to adapt to the low temperature spontaneously with recovered nitrogen removal performance and microbial abundances. Methanogens in hydrogel beads and AOA and anammox on the membrane were observed in the reactor by qPCR and 16S sequencing across all operational temperatures.

Keywords: Carbon and Nitrogen Removal, Mainstream Wastewater, Anaerobic Digestion, Anammox and AOA.

### 1. Introduction

The treatment of water accounts for ~2% of U.S. energy consumption, while the aeration requirements of aerobic organisms consuming ammonium (NH₄⁺—N) and organic carbon make up to more than 50% of this energy usage. Compared with aerobic treatments, anaerobic removal of nitrogen and organic carbon can significantly reduce both the cost and environmental impact of wastewater treatments. Anaerobic ammonia-oxidizing (anammox) bacteria can significantly reduce the energy demand for aeration in nitrogen removal. Likewise, anaerobic digestion (AD) converts organic material to methane (CH₄) with no requirement for air and an output of methane fuel. However, currently both anammox processes and anaerobic digestions are primarily applied to side stream treatments at high temperatures and high concentrations of organics (sludge treatment in an anaerobic digester) or high concentrations of ammonium (reject water from the digesters). Mainstream anammox process is still challenging due to low ammonium concentration, low water temperature and the presence of inhibitory organic components, while mainstream anaerobic digestion is challenging due to low organic strength and low temperature and also difficulties in recovery CH₄.

Anammox-based processes typically comprise two consecutive steps: ammonia-oxidizing microorganisms (AOM) aerobically oxidize ammonium to nitrite, while anammox subsequently convert NH₄⁺ and the NO₂⁻ generated (by AOM) to nitrogen gas. The low NH₄⁺ concentration in mainstream wastewater (20-60 mg N/L) limits the concomitant growth of AOM and anammox. Anammox has an optimal temperature for activity in the range of 25-40° C. and the activity decreases dramatically with decreasing temperature. The low temperature in mainstream wastewater, with typical temperature of 15-25° C. and occasionally 10° C. during winter season, significantly reduces reaction activity and growth rate of both anammox and AOM. Extensive research has been dedicated to mainstream anammox processes, most of which relied on externally supplied nitrite which is scarce in raw wastewater. Therefore, new ways are required to reliably supply nitrite to anammox bacteria, and an attractive alternative is to introduce ammonia oxidizing archaea (AOA) to supply nitrite to anammox instead of canonical ammonia-oxidizing bacteria (AOB).

AOA have remarkably high affinities for both oxygen (0.01 mg/L) and ammonium (0.001 mg/L), enabling activity at extremely low ammonium concentration. The presence of AOA in wastewater treatments has been explored previously, although not satisfactorily reduced to practice, and an intentional integration of AOA into actual anammox-based wastewater treatments has not yet been achieved. The possibility of synergy of AOA with anammox bacteria is proposed herein, including in environments of ammonium/oxygen counter diffusion, e.g., with a biofilm model, attributing the success to the different affinities for ammonium/oxygen of AOA and anammox bacteria.

Another issue of implementing partial nitritation-anammox (PN-anammox) in the mainline is organic matter which leads to the proliferation of heterotrophic bacteria, competing with AOMs for oxygen and anammox bacteria for nitrite. Therefore, organic matter reduces anammox abundance and activity and also contributes to the fouling of anammox systems using membrane bioreactors (MBRs). As an effective strategy to extend retention of slow-growing microorganisms (such as anammox bacteria and methanogen), MBRs are proposed herein to be used in anammox-based processes and anaerobic digestion. MBRs can be made and used to apply AD to mainstream wastewater treatments to generate methane from influent COD which can also benefit as an COD pretreatment step for PN-anammox systems. In one-stage PN-anammox systems, typically a certain level of dissolved oxygen (DO) is maintained to support the oxygen-demanding nitritation, hence inhibiting anaerobes to access the COD from the bulk liquid, and instead oxygen in the bulk liquid can promote fast-growing aerobic heterotrophs. It is therefore difficult to integrate anaerobic digestion and PN-anammox systems for simultaneous anaerobic carbon and nitrogen removal using previous systems.

An objective of this example is to design and operate a one-stage continuous-flow pilot scale reactor to achieve both anaerobic and nitrogen removal from low strength and low temperature mainstream wastewater. In this example, a one-stage continuous-flow pilot scale reactor with an AOA-anammox biofilm coated counter-diffusion membrane and hydrogel encapsulated anaerobic digestion sludge was operated on the mainstream (primary effluent) of a municipal wastewater treatment plant (WWTP). The pilot successfully removed C anaerobically and N autotrophically with minimal aeration (with dissolved oxygen undetectable in the reactor) at temperatures ranging from 10-25° C. for 160 days of operation.

### 2. Materials and Methods

### AOA and Anammox Biomass and Anaerobic Digestion Sludge

An AOA isolate, Nitrososphaera viennensis was grown in limited mineral media aerobically at 37° C. and pH 7.5 with 1 mM NH₄⁺ and 0.1 mM pyruvate. Anammox biomass was obtained from a WWTP in Rotterdam Sluisjesdijk, Netherlands and was maintained anaerobically in a plug-flow glass column supplied with 1 mM NH₄⁺ and 1.3 mM NO₂⁻ and mineral media at 30° C. in the lab for more than six months. Anaerobic digester sludge was collected from an anerobic digester at the West Point Treatment Plant (Seattle, WA, United States). Activity of anammox sludge and AOA culture were monitored and confirmed by measuring the daily dynamics of nitrogen species in the influent/effluent of the maintenance columns or in the culturing bottles.

### Membrane Coating Procedure

ZeeLung lab scale membranes (SUEZ Water Technologies & Solutions, Trevose, PA, USA) with a series of gas transfer tubes with a total surface area of 0.25 m² were used in this example. Membrane modules were pretreated with 1 mM L-DOPA (also known as levodopa and 1-3,4-dihydroxyphenylalanine) in 10 mM Tris at pH 8.5 (final concentration) in a shallow open container overnight and then rinsed and soaked in 400 mL 0.01% poly-L-lysine solution for 3 hours before coating with biomass. The enriched AOA was concentrated from 15 L to 400 mL by tangential flow filtration through a Pellicon XL50 module with Durapore 0.1 μm Membrane (MilliporeSigma, Burlington, MA). 100 mL of anammox granular sludge was blended for 2 mins and the slurry was centrifuged at 1800 rpm for 5 mins to separate the anammox sludge from the liquid. Supernatant liquid was discarded and anammox sludge was resuspended and mixed in the concentrated AOA culture. After being rinsed with DI water, the membrane module was soaked in the AOA-Anammox mixture for 2 hours for biomass coating.

### Preparation of Hydrogel Beads

0.8 L hydrogel gel beads were prepared with anaerobic digester sludge to remove COD in the anaerobic bulk fluid and suppress the growth of heterotopic microorganisms on the hollow fiber membrane that would otherwise cause fouling of the membrane. Anaerobic digestion sludge was homogenized using a blender and then sieved (250 μm) to remove large particles and was diluted with DI water to a sludge concentration of 1 g/L before hydrogel encapsulation. Anaerobic digester sludge was encapsulated in PVA-SA hydrogel beads, with final concentration (w/v) of 10% polyvinyl alcohol (PVA) and 1% sodium alginate (SA). The PVA was 99% more hydrolyzed with a molecular weight of 89-98 kDa (Sigma-Aldrich, cat. No. 341584). A mixed solution of 15% PVA and 1.5% SA were prepared and autoclaved at 121° C. for 30 mins and cooled to room temperature before mixing with biomass. Anaerobic digester sludge collected from an anerobic digester from the West Point Treatment Plant (Seattle, WA, United States) was homogenized using a blender and then sieved with a 250 μm sized sieve to remove large particles. The resulting biomass slurry and PVA-SA polymer were mixed at a 2:1 ratio (v/v). Beads were prepared by dropping the mixture into 10 L of crosslinking solution containing 2% CaCl₂), 3% boric acid and 0.1% high molecular weight chitosan at pH 5. The mixture was sparged with N₂ gas to ensure anaerobic conditions. Hydrogel beads were soaked in the crosslinking solution for 1 hour followed by overnight soaking in 10 L of 0.5 M Na₂SO₄. The hydrogel beads were rinsed with DI water and transferred in the reactor container.

### Startup and Onsite Operation of the Membrane Reactor

Two membranes were prepared with following the same coating procedures above and operated sequentially. A membrane reactor with AOA-anammox but without integration of hydrogel encapsulated digester sludge (membrane reactor) was firstly operated for 75 days and resulted in a quick failure in both COD and nitrogen reduction due the membrane fouling. The second reactor was then operated with integration of AOA-anammox membrane and hydrogel encapsulated digester sludge (membrane-hydrogel reactor) that demonstrated constant COD and nitrogen removal in 160 days of pilot operation.

For both reactors, the membranes were installed in a close-fitting cuboid container (L*W*H: 8.3 in*3.5 in*37.5 in) made of polycarbonate plastic with a working volume of 5.5 L. Air was supplied to the membrane using a peristaltic pump. Purging of N₂ gas and liquid recirculation were used for mixing and controlling DO. N₂ gas was provided via a compressed nitrogen tank. Recirculation passed through a filter made with a funnel wrapped by a net to separate the hydrogel beads. The N₂ gas flowrate was around 30 mL/min, which was the minimal flow rate required to keep all hydrogel beads suspended. The combination of these two mixing methods was used because of the cuboid shape of reactor and limited mixing equipment available in the lab; for an example engineered system, mixing can be achieved with a mechanical rotator. During the startup period, the reactors were operated with a hydraulic retention time (HRT) of 2 days and fed with synthetic wastewater made of the same recipe used for the AOA culture above, containing ammonium and nitrate but no organic carbon. DO in the reactor was maintained at a low level under 0.3 mgO₂/L. The reactors were operated at 25° C. heated by wrapping with tubing recirculating warm water from a water bath.

The first AOA-anammox membrane reactor was transported to the Everett WWTP (Everett, WA) for onsite pilot operation with primary effluent as the feed, after confirmation of nitrogen removal activity. The AOA-anammox membrane reactor was operated at 25° C. during a pilot operation. For the membrane-hydrogel reactor, hydrogel encapsulated anaerobic digestion sludge was placed into the reactor before onsite pilot operation. The AOA-anammox-AD membrane-hydrogel reactor was operated at 25° C., 16° C. and 10° C. sequentially during the pilot operation. HRT was 3.7 days during the entire pilot operation. DO in the bulk liquid was maintained at almost 0 mg/L (undetectable by an optical DO probe). During day 0-17, the membrane-hydrogel reactor, which operated at 25° C., experienced operating disturbance due to an electricity outrage, equipment issues, and subsequent recovery period. Therefore day 0-17 was not representative of general performance and that period was therefore excluded from data analysis.

### Monitoring of Reactor Performance

DO and temperature were monitored by a FireSting®-O₂ optical oxygen and temperature meter (Pyroscience, Aachen, Germany). The pH was monitored using a portable pH probe (ThermoFisher Scientific, Waltham, MA). Liquid sampled from the reactor was filtered with 0.45 μm filter paper (VWR, Radnor, PA) for the following analyses; NH₄⁺—N, NO₂⁻—N and NO₃⁻—N were measured with Gallery™ Automated Photometric Analyzer (ThermoFisher Scientific, Waltham, MA) and soluble COD (sCOD) was measured using the COD Digestion Vials-Low Range kit (Hach, Loveland, CO) following the Standard Method 5220 D. Analysis of total/volatile suspended solids (TSS/VSS) in the influent and effluent was performed following the Standard Method 2540. The membrane fibers were cut at the end of the operation of the membrane-hydrogel reactor and biomass was detached off the fibers by using a sonicator and measured for TSS and VSS to quantify the biomass.

### Reactor Activity

At the end of pilot operation, the biomass activity of the reactor at 25° C., 16° C. and 10° C. was monitored by in-situ batch tests in triplicate. All tests for the three temperatures were conducted within a span of 48 hours to avoid a variation resulting from significant change in amount of biomass in the reactor. In batch tests, the reactor was fed with 400 mL of primary effluent and reacted for 3 hours. The aeration rate during the batch tests was maintained at 3 cc/mins. This aeration rate was selected because, in the case of at least the pilot operation, the NH₄⁺—N reaction rate did not further increase with higher aeration rates, and DO in the bulk liquid was maintained as unmeasurable by the DO sensor at this aeration rate. Liquid samples were collected at 30 mins intervals and measured for NH₄⁺—N, NO₂⁻—N and NO₃⁻—N.

DNA Extraction, qPCR and 16S Sequencing

qPCR and 16S amplicon sequencing was used to monitor the microbial community in the biofilm right after membrane coating (startup) and through the experiment. To extract DNA, biofilm from the membrane was collected by swabbing biomass from three different positions of the membrane for each sampling. Five hydrogel beads from each sampling point were homogenized with a bullet blender (Next Advance, Troy, NY) and cooled with dry ice at the maximum speed for 30 mins. DNA was also extracted from three randomly collected primary effluent and used as comparison. DNA was extracted using the Qiagen DNeasy PowerBiofilm Kit (Qiagen. Hilden, Germany) following the manufacturer's protocol. DNA samples were measured for quantity using the Quibit4 (Invitrogen, Waltham, MA) and then stored at −20° C. until further processing.

qPCR was performed in duplicate to quantify the abundances of amoA of AOA, 16S rRNA of anammox, amoA of AOB, nxrB of NOB, mcrA of methanogen and universal 16S rRNA representing the total Eubacteria on a LightCycler® system (Roche, Rotkreuz, Switzerland) using the primers and reaction conditions listed in Table 1.

The V4-V5 region of the 16S rRNA gene was amplified by PCR using primer 515F-Y/926R. An averaged 237644 of 250 bp pair-end reads were received for each sample. Bioinformatics for microbial community analysis was performed using the QIIME2 and the DADA2 denoising algorithm. The Silva 132 99% database was used for taxonomic analysis. Amplicon sequencing variants (ASVs) were subjected for non-metric multidimensional scaling (NMDS) analysis of Bray-Curtis dissimilarity distance metric to compare the similarity between the microbial communities in the biofilm, hydrogel beads, and primary effluent.

### 3. Results

### 3.1 COD and Nitrogen Removal in the Reactor During Pilot Operation

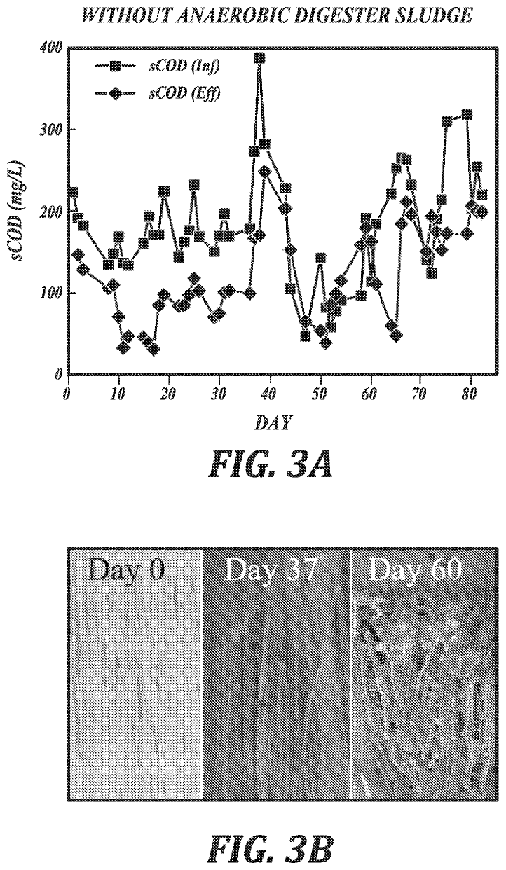

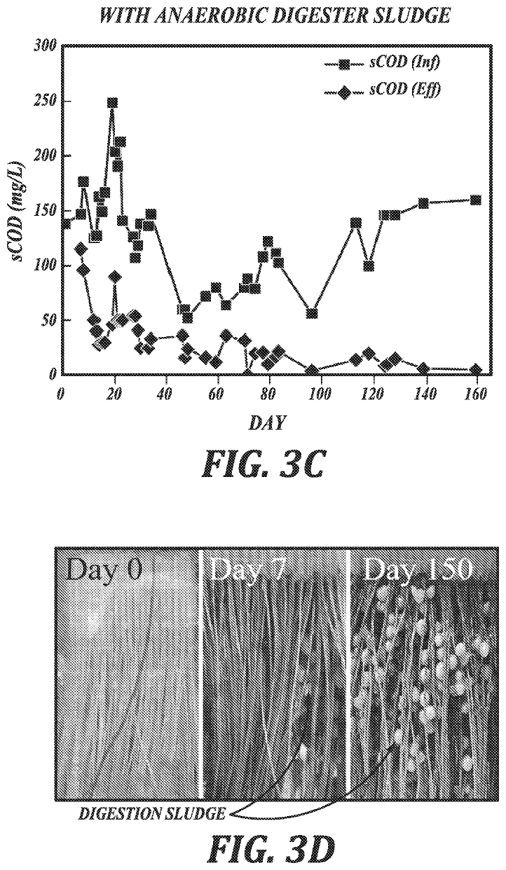

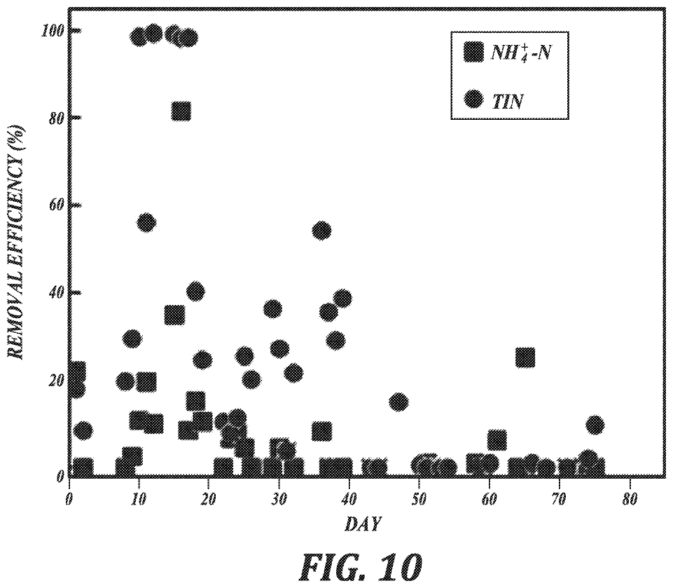

Pilot operation of the AOA-anammox membrane reactor was first conducted without hydrogel encapsulated anaerobic digestion sludge, in which a rapid membrane biofouling followed by a collapse in nitrogen and carbon removal within 60 days was observed in the reactor (FIGS. 3A, 3B, and 10). Thus, hydrogel encapsulated anaerobic digestion sludge were prepared and placed in the bulk liquid of a new membrane-hydrogel reactor to control membrane fouling at the start of pilot operation. The aeration rate was close to the O₂ consumption rate, therefore minimized energy loss through escape of oxygen from the bulk liquid to the atmosphere.

During the 160-day pilot operation of the membrane-hydrogel reactor fed with actual primary effluent, steady sCOD removal (76.2±15.5%) was observed in the membrane-hydrogel reactor, with an average sCOD concentration of 123.7±46.4 mg/L and 27.2±18.8 mg/L in the influent and effluent, respectively (FIG. 3C). No obvious effect of temperature on the COD removal was observed. An increased brown-red coloring of the membrane fibers indicated growth of anammox biomass on the membrane (FIG. 3D). Attributing to the hydrogel beads with anaerobic digester sludge removing the COD in the reactor, no obvious membrane fouling was observed even after 149 days of pilot operation (FIG. 3D).

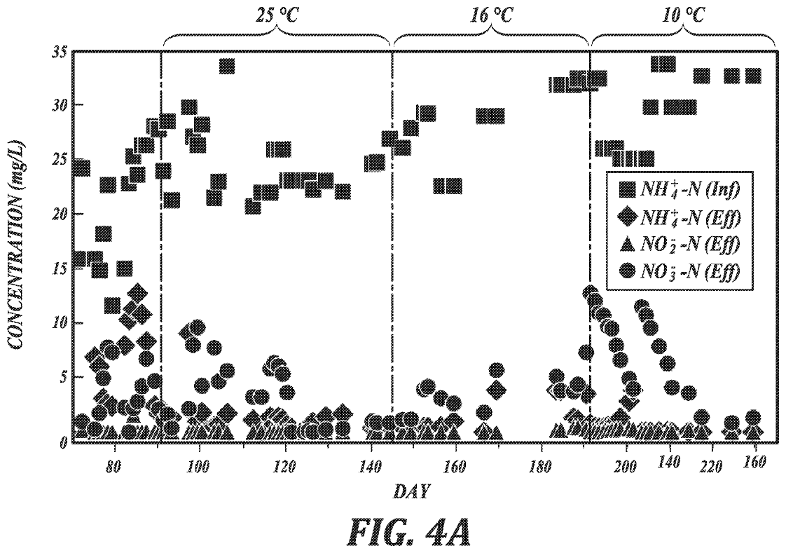

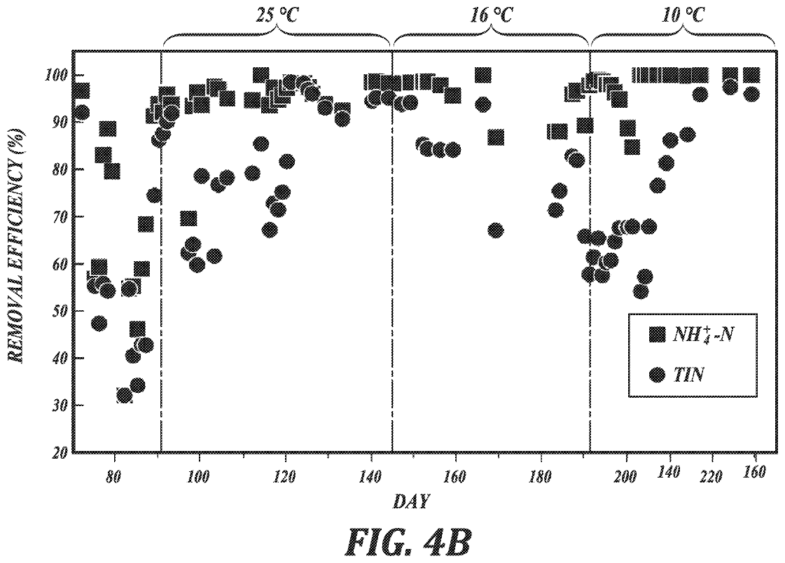

Once inhibition of the organic carbon and membrane fouling was successfully controlled in the membrane-hydrogel reactor, high NH₄⁺—N and TIN removal (FIGS. 4A and 4B) was also observed with overall removal efficiencies of 95.8±5.0% for NH₄⁺—N and 78.9±13.2% for TIN. At the three operating temperatures tested, the reactor demonstrated comparable NH₄⁺—N removal efficiency and somewhat decreased TIN removal efficiency at the lower temperature, with averaged removal efficiencies of 86.5±12.4%, 80.9±9.2% and 71.6%±14.2% for TIN at 25° C., 16° C., and 10° C., respectively. Increased performance was observed during the last three weeks at 10° C., with the removal efficiency rising to 100±0% for NH₄⁺—N and 92.6±5.3% for TIN.

### 3.2 Nitrogen Removal Activity at Different Temperatures

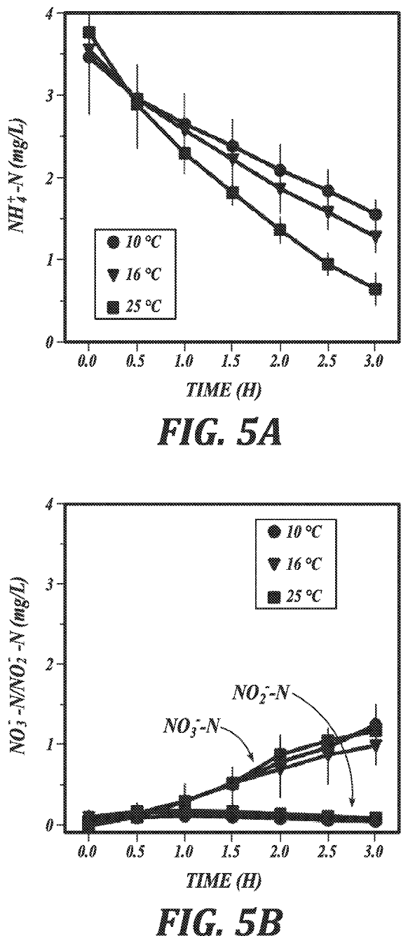

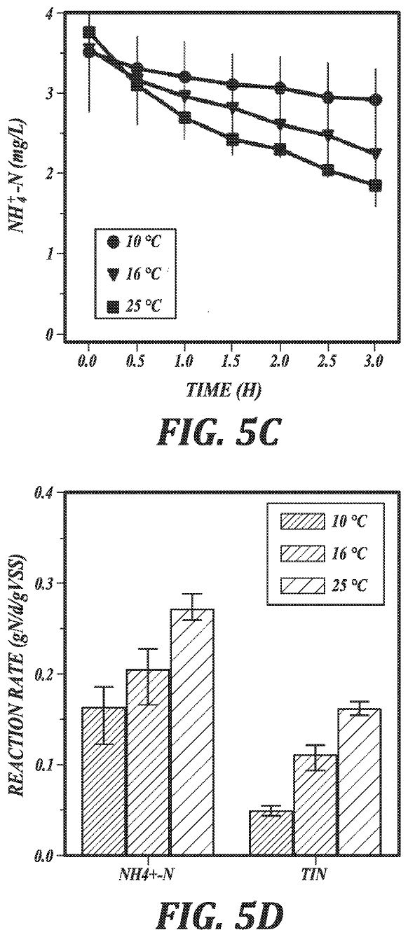

Temperature showed significant effect on the biomass activity, as demonstrated by the different rates of NH₄⁺—N and TIN reduction at the different temperatures (FIGS. 5A, 5B, 5C, and 5D). Unexpectedly, under all three tested temperatures, constant reduction of NH₄⁺—N and TIN were observed in the reactor despite the different reaction rates, indicating that the cooperation of AOMs and anammox was functioning under all tested temperature conditions. A very limited amount of NO₂⁻—N, with peak concentrations of 0.16±0.04 mg/L, and a certain level of NO₃⁻—N accumulated during the activity tests in the reactor at all three temperatures. Rates of both NH₄⁺—N and TIN reduction decreased with the lower temperature (ANOVA test, P<0.01). The lower temperature range showed less inhibition on the NH₄⁺—N reduction rate (r-NH₄⁺—N) than of TIN (r-TIN), as r-NH₄⁺—N decreased by 38.1% while the r-TIN decreased by 69.2% from 25° C. to 10° C., respectively.

### 3.4 Functional Microorganisms and Microbial Community in the Reactor

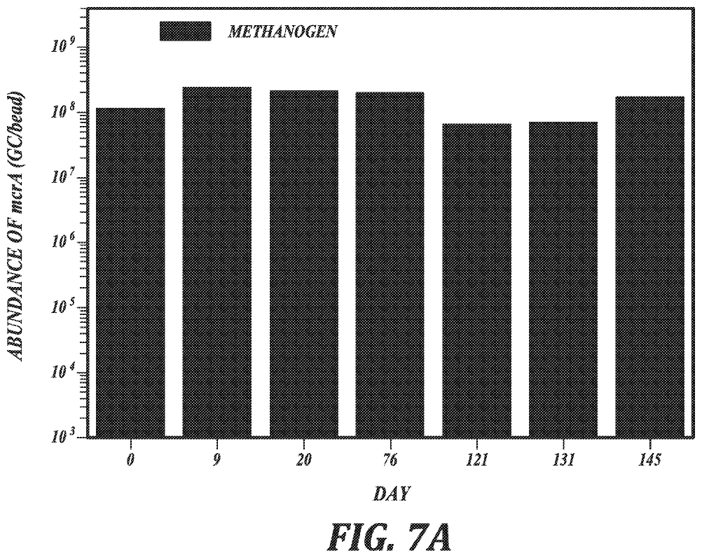

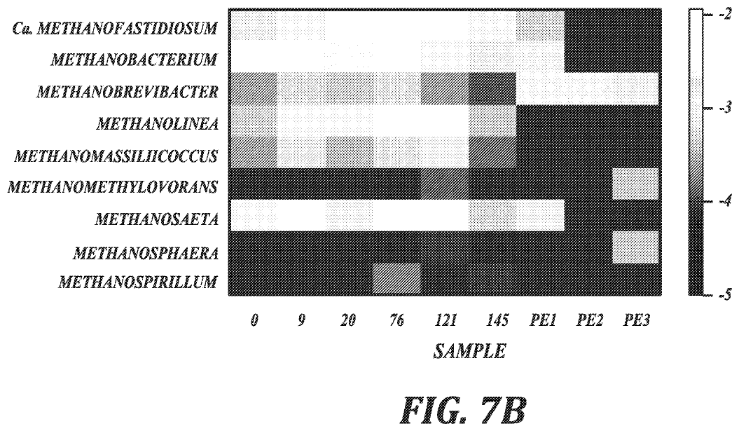

Functional microorganisms involved in autotrophic nitrogen removal (AOA and anammox bacteria growing on the membrane) and anaerobic carbon removal (methanogens growing in hydrogel beads) were found thriving in their designed immobilized systems by both qPCR and 16S sequencing. Methanogens were found to be abundant in the hydrogel beads during the entire pilot operation even at lower temperatures (FIG. 7A). The dominance of methanogens in the beads was confirmed by 16S sequencing, which detected 9 different methanogen genera. The Methanobacteria was most abundant, followed by the Ca. Methanofastidiosum, Methanosaeta, and Methanolinea (FIG. 7B).

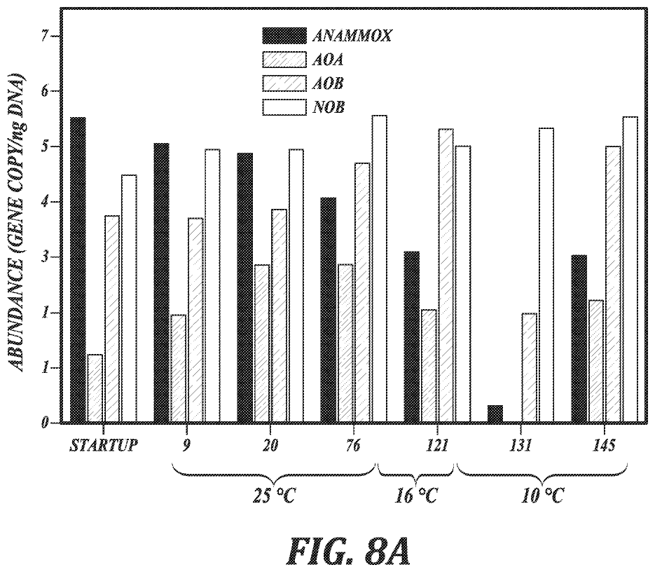

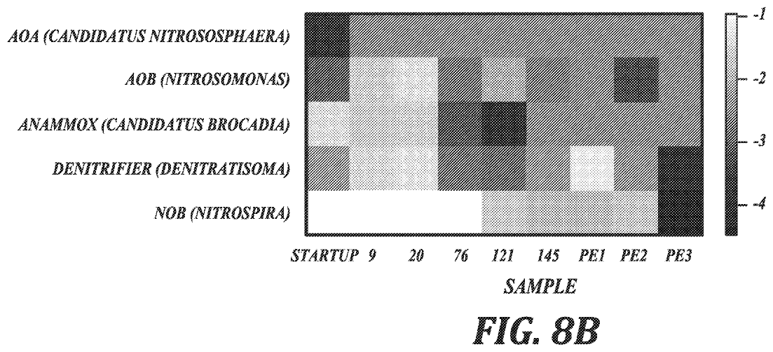

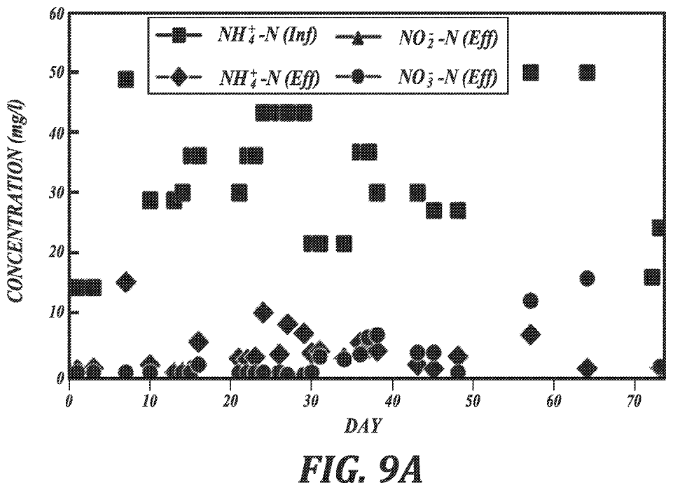

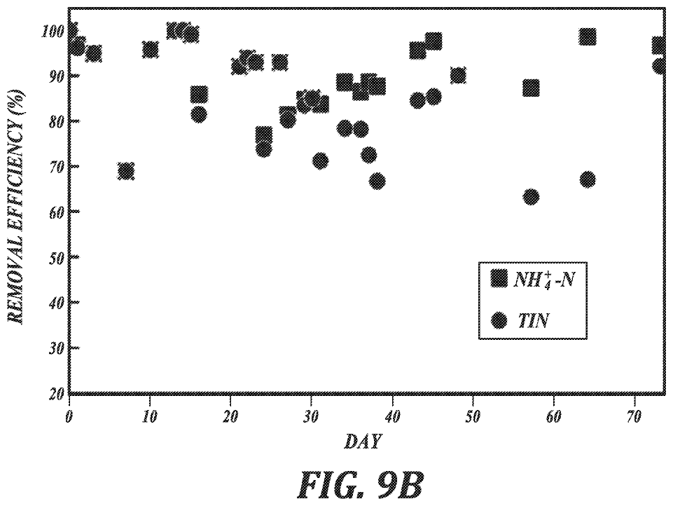

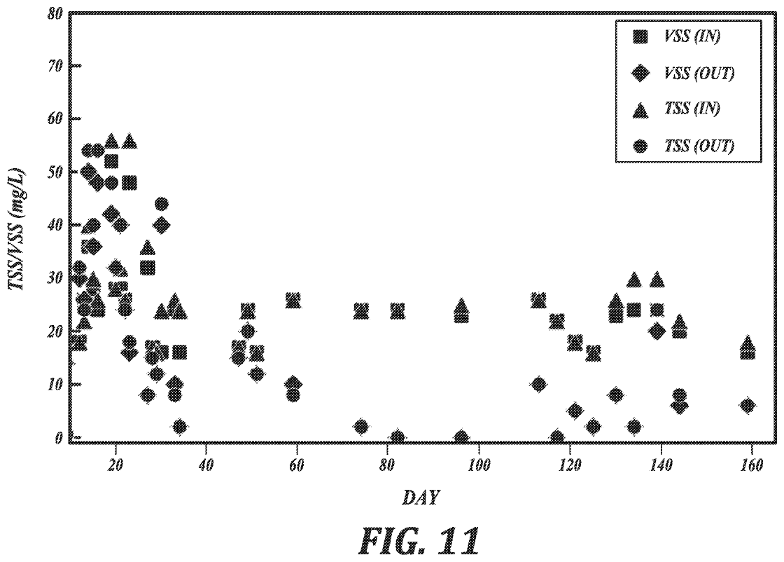

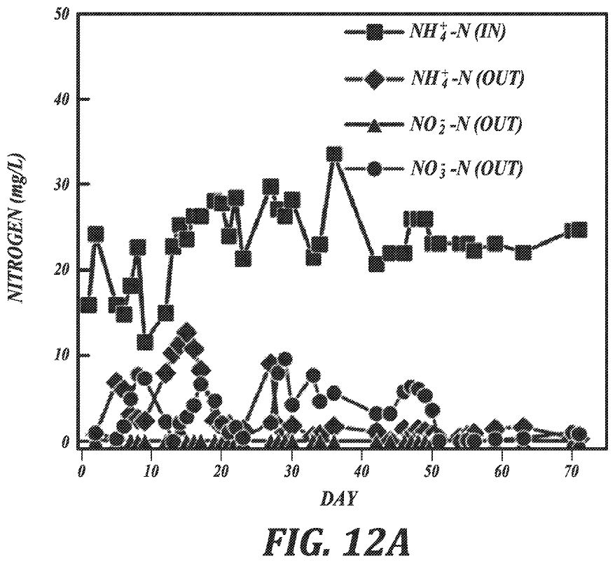

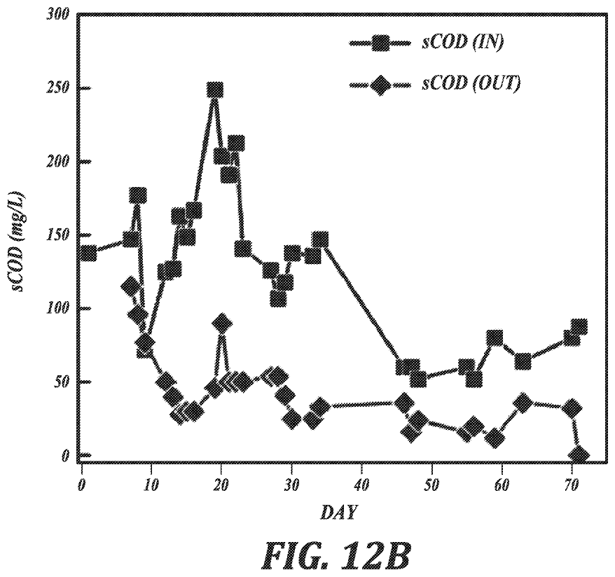

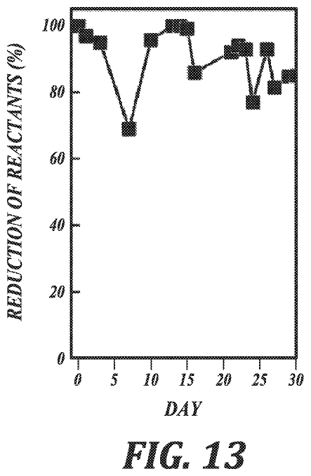

The growth of AOA and anammox bacteria were detected by qPCR in the biofilm during the entire operation, except one sample at day 131 which was taken from the operation at 10° C., which therefore showed the temporary negative affect on the growth of both AOA and anammox (FIG. 8A). However, the microorganisms demonstrated the ability to recover from low temperature as indicated by a decline at the beginning of the colder period (day 131) but then a recovered abundance (day 145) of both AOA and anammox, to a level comparable to that at the beginning of the operation at 10° C. AOB similarly declined at the beginning and then recovered abundance, while the NOB remained at a relatively steady abundance during the entire operation at 10° C. The change in the abundance of anammox corresponded with the initially decreasing and later recovering NH₄⁺—N and TIN removal efficiency in the reactor. In agreement with the qPCR results, coexistence of anammox bacteria, AOA, AOB (Nitrosomonas) and NOB (Nitrospira) were detected in the biofilm samples by 16S sequencing (FIG. 8B). The Candidatus (Ca.) Brocadia was the only detected anammox genus. The Nitrososphaera, the genus N. viennensis belongs to, was the only detected AOA. The most abundant NOB was Nitrospira (in which comammox was not a major species as it was not detected by qPCR) and the two dominant ASVs (>99% in abundance) of the Nitrospira showed high similarity (>99%) to Nitrospira defluvii by blast alignment. Denitratisoma, which has both aerobic and anaerobic denitrifying traits and that is commonly found in anammox-based reactors, was detected in the biofilms through the entire operation. Planktonic biomass was excluded from analysis due to the negligible amount of VSS concentration (FIG. 11) and the undetectable concentrations AOA and anammox bacteria.

### 4. Discussion

### 4.1 Integration of Anaerobic Digestion and PN-Anammox in the Same System

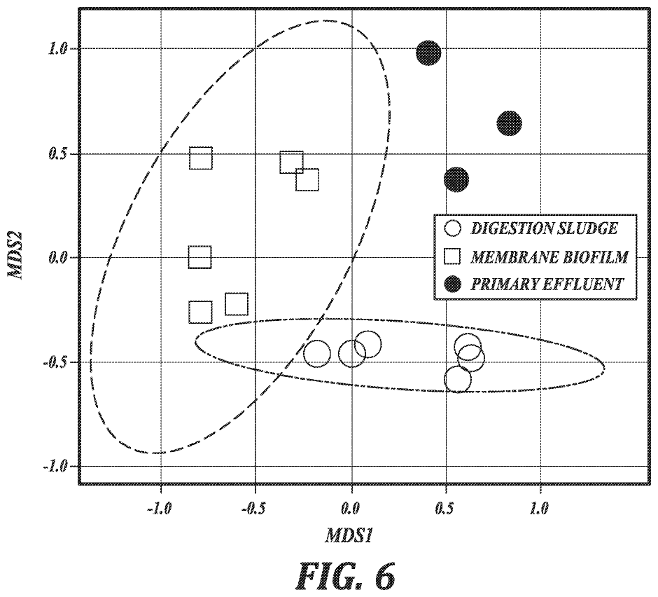

This example integrated anaerobic digestion into a mainstream one-stage AOA-anammox based PN-anammox system for autotrophic nitrogen removal and anaerobic carbon removal from primary municipal wastewater with low substrate concentrations and at low temperature. Compared with the conventional two-stage system, a one-stage system is more compact and as a result it can significantly reduce the areal space requirement and construction cost. Good autotrophic nitrogen and anaerobic COD removal were achieved in the reactor during the long-term pilot operation, even at low temperatures down to 10° C. This is believed to be the first successful attempt of combining anaerobic digestion and PN-anammox process in the same system and also the first successful attempt of intentional integration of AOA into actual anammox-based wastewater treatment. To retain and separate the two designed microbial communities for autotrophic nitrogen and anaerobic carbon removal, two different and targeted immobilization strategies were used, namely the membrane coating with synthetic biofilm of AOA-anammox and hydrogel encapsulation of anaerobic digestion sludge. The two targeted immobilization procedures also allowed the independent responses of the synthetic microbial communities in their respective niches in the same system (FIG. 6). Taking advantage of the high oxygen and ammonium affinity of AOA, complete ammonium removal with almost no oxygen reaching the bulk liquid in the reactor was achieved, allowing fermentative processes to occur as highlighted by these results showing a stable methanogen population in the hydrogel beads over time (FIGS. 8A and 8B). Fast-growing and oxygen-consuming heterotrophs typically hamper nitritation and anammox activity and are also commonly contributing to failure of anammox-based membrane reactor systems due to excessive fouling. Integration of anaerobic COD removal into the reactor relieved organic carbon inhibition of anammox and also avoided membrane fouling.

### 4.2 Performance of PN-Anammox and Anaerobic COD Removal

In the hydrogel-membrane reactor, excellent simultaneous COD and nitrogen removal was observed. With the hydrogel encapsulated anaerobic digestion sludge, a relatively stable sCOD removal (76.2±15.5%) and effluent sCOD (27.2±18.8 mg/L) were observed in the reactor and the system was not highly sensitive to temperature (FIG. 3B). In contrast, the previous membrane reactor without hydrogel encapsulated anaerobic digestion sludge resulted in a quick failure in COD removal (FIG. 3A) indicating the role of hydrogel encapsulated anaerobic digestion sludge. The resilience of anaerobic digestion to low temperature is supported by the abundance of the methanogens in the hydrogel beads across the entire pilot operation between 10-25° C. temperatures, as measured by qPCR and 16S sequencing (FIGS. 7A and 7B). In alignment with the abundant methanogen observed in this example, the methanogenesis at low COD condition has also been observed. Methanosaeta showing high affinity to COD is considered playing a role in anaerobic digestion at low COD condition that is also a major methanogen genus detected in this study (FIG. 7B). The steady anaerobic COD removal and abundance of methanogens at all temperatures tested as well as the absence of membrane fouling and low VSS in the effluent solidly supported the constant growth of methanogens at all temperatures tested. The disclosed approaches can be implemented to optimize methane production, and recovery strategies can allow further process economies to be achieved while also reducing levels of greenhouse gas emissions.

The greater fluctuation of removal efficiencies and abundances of functional microorganisms for nitrogen metabolism indicate the PN-anammox process can be, at least in some instances, the more vulnerable process, especially at the lower temperature. In previous efforts of the PN-anammox process for mainstream treatment, especially those studies on actual wastewater, most reactors were successfully operated at moderately low temperatures (i.e., higher than 15° C.). Although the activity of anammox can occur at low temperatures, lower temperatures (e.g., less than 15° C.) usually result in significantly deteriorated performance of previous anammox-based reactors as a consequence of inhibited biomass activity, hence posing the question as to whether strain selection (of either anammox or AOB) is a bottleneck for mainstream anammox systems. In previous studies, significant decreases in the performance of PN-anammox reactors were observed at 10° C., 11° C., and 15° C., and one of the major issues identified was an unreliable nitrite supply source, indicating that AOB were limiting the process. In this example. AOA was used, as these organisms possess a much higher affinity for ammonium; AOA N. viennensis has a km,NH₄ of 0.81 μM while AOB has a km,NH₄ of ~20-2000 μM.

Anammox and AOA were coated on a hollow fiber membrane and demonstrated good performance with actual mainstream wastewater even at 10° C. even achieving complete removal of NH₄⁺—N and 92.6±5.3% removal of TIN (with TIN_{eff} of 2.3±1.5 mg/L) after adaptation to low temperature in the reactor. These removal efficiencies and effluent qualities were even better than previous PN-anammox reactors operated at higher temperatures: for example, 5.7±1.3 or 8.0±2.6 mg/L of two previous MBBRs treating mainstream wastewater at 15° C. Additionally, the biomass specific N removal rate, which were 0.074±0.011 g NH₄⁺—N/d/g VSS and 0.061±0.013 g TIN/d/g TSS at 10° C. (FIGS. 5A-5D) were higher than previously reported values in anammox reactors for mainstream wastewater treatment. For example, previous studies reported specific removal rates of 0.005-0.016 NH₄⁺—N/d/gVSS at 20-25° C., and 0.03 to 0.07 gTN/gVSS/d at 25° C. for PN-anammox reactors.

### 4.3 Impact of Temperature on the Reactor and Functional Microorganisms

Methanogen possess the ability to grow in a wide temperature range, as observed in this example (FIGS. 7A and 7B). Methanobacterium, which was the most abundant genus of methanogens in the reactor, contains strains able to grow at low temperatures. Compared with anaerobic COD removal, autotrophic nitrogen removal can involve more functional microbial groups, such as AOA, AOB, and anammox bacteria. In this example, the coexistence of AOA and AOB was observed. Without wishing to be bound by any particular theory, this is possibly due to different concentration gradients of ammonium and oxygen in the biofilm; since oxygen is provided from the base and the ammonium diffuses into the biofilm from the bulk liquid, ammonium concentrations will be extremely low at the base hence offering a niche space for AOA (as they have high affinities for ammonium) while AOB and anammox have a niche toward the biofilm middle and outer edge, respectively. Therefore, AOA and AOB may partition ammonium oxidation across the biofilm and therefore work hand in hand to achieve high ammonium removal.

Surprisingly, the permanent presence of NOB (canonical Nitrospira) (FIG. 7B) but no significant nitrate accumulation was observed in the reactor, suggesting NOB were metabolically active during the pilot operation, either utilizing an alternative pathway besides nitrite oxidation at oxygen-limited conditions or being primarily dormant under the suboptimal growth conditions, or it could have been that there was another unknown sink for the produced nitrate. Persistence of Nitrospira has been observed in inactive layers of biofilm, and activated sludge experiencing nitrogen starvation, where they might persist rather than thrive. NOB presence was also found not affecting the partial nitritation in an anammox reactor.

Besides NOB, the presence of denitrifying bacteria (Denitratisoma) was also observed. Denitratisoma can show cooperation in nitrogen removal with AnAOB and can be increasing in relative abundance at lower temperatures in a anammox process. With the existence of denitrifiers, a NO₂⁻ oxidation/NO₃⁻ reduction loop driven by incomplete heterotrophic denitrification can contribute to the unexpectedly high NOB ratios. Without wishing to be bound by any particular theory, although the denitrifiers were present in these systems, it may be unlikely that denitrification made significant contribution to the nitrogen reduction as the comparison of the failed reactor with no anaerobic digestion sludge and the successful reactor with the anaerobic digestion sludge indicated that the COD was mainly removed by the anaerobic digestion sludge rather than the denitrifiers. Additionally, significant nitrate accumulation was only observed during the early phased of operation at low temperature (Day 120-140), when abundance of anammox and AOA decreased largely (FIG. 8A) but denitrifiers remained a high abundance (FIG. 8B). Without wishing to be bound by any particular theory, this may indicate that PN-anammox played a more useful role than the denitrification in nitrogen removal, however, further studies can help to better understand the contribution on NOB and heterotrophs in anammox based systems.

This example shows that the growth of AOA, AOB, and anammox was more vulnerable to lower temperatures than that of NOB (FIGS. 8A and 8B). However, anammox bacteria possess the ability to adapt to low temperature, as the anammox activity plummeted after initial exposure to 10° C. but then experienced a recovery of TIN removal and anammox abundance along extended operation at 10° C. (FIGS. 4A, 4B, 8A, and 8B). Without wishing to be bound by any particular theory, AOA may be a major contributor in ammonium oxidation in cold seasons in WWTPs. This example shows stable ammonium removal and high activities at low temperatures with AOA-anammox (FIGS. 4A, 4B, 5A, 5B, 5C, and 5D), while previous AOB-anammox systems typically suffer sharply decreased ammonium removal rates when the operational temperature falls below 15° C. Although it remains unknown to what exact extent AOA contributed to the total nitrification, the better nitrogen removal performance of the disclosed AOA-integrated PN-anammox systems, if compared to previous AOB-based systems, can suggest AOA played a role in establishing stable nitrogen removal at colder temperatures and low ammonium concentrations.

### 4.4 Application and Future Work

This example provides a first proof of principle of the integration of simultaneous mainstream anaerobic digestion and PN-anammox processes, filling the gap in research and satisfying the demands for efficient carbon and nitrogen removal at low cost in municipal wastewater treatments. The pilot operation with actual primary municipal wastewater indicates the practical application of this technology to mainstream treatment. The good performance of the reactor at the wide temperature range, 10-25° C., and the ability of the reactor system to adapt to low temperature, allows for the wide application of this technology to different climates including cold areas including year-round operation.

Large scale membrane modules are available in the market and membrane coating and hydrogel preparation procedures used in this example can be applied to large scale reactors directly, suggesting easy scale-up of this technology. This example also identified several factors for the successful operation of the integrated AD-PN-anammox system. Efficient anaerobic COD removal is a prerequisite to avoid membrane fouling for successful membrane-based PN-anammox. Preventing oxygen from reaching the bulk liquid, which is jointly determined by the aeration rate and also consumption rate by the PN-anammox process, is useful to maintain an anaerobic condition favorable for AD. Considering the typical fluctuating influent NH₄⁺—N concertation and flowrate in full-scale wastewater treatments, a precise control of the aeration based on the real-time NH₄⁺—N load and oxygen demands can be implemented to ensure the optimal performance of this technology. Although able to recover, the PN-anammox biomass is vulnerable to sudden exposure to low temperature, with decreased activity and biomass amount. Thus, high biomass concentration for PN-anammox (such as possible through hydrogel encapsulation or dense biofilm formation) are needed to buffer out removal efficiencies during possible sudden changes in temperatures during winter.

### 5. Conclusion

This example combines anaerobic digestion with PN-anammox, for the first time, for simultaneous anaerobic carbon and autotrophic nitrogen removal from actual mainstream wastewater at low operational temperatures. AOA was also intentionally and successfully integrated into the mainstream PN-anammox, for the first time. In long-term pilot operation, the reactor was operated with hydrogel encapsulated anaerobic digestion sludge and a hollow fiber membrane coated with a synthetically assembled AOA-anammox biofilm, in a single reactor unit. The combined performance of these two separately immobilized microbial communities demonstrated unexpectedly good anaerobic COD and autotrophic nitrogen removal, with an overall high removal efficiency of 76.2±15.5% for COD, 95.8±5.0% for NH₄⁺—N and 78.9±13.2% for TIN under the three different temperatures (25, 16 and 10° C.). Membrane fouling by common heterotrophs was suppressed with the integration of anaerobic COD removal, thus enabling a successful PN-anammox process in a reactor.

### Example 2. Mainstream Nitrogen Removal from Low Temperature and Low Ammonium Strength Municipal Wastewater Using Hydrogel-Encapsulated Comammox and Anammox

### Abstract

Application of partial nitritation (PN)-anammox to mainstream wastewater treatment faces challenges in low water temperature and low ammonium strength. In this example, a continuous flow PN-anammox reactor with hydrogel-encapsulated comammox and anammox was designed and operated for nitrogen removal from mainstream wastewater with low temperature. Long-term operation with synthetic and real wastewater as the feed demonstrated nearly complete ammonium and total inorganic nitrogen (TIN) removal by the reactor at temperatures as low as 10° C. A significantly decreased nitrogen removal performance and biomass activity was observed in the reactor at 4° C. before a selective heating strategy was employed. A novel heating technology using radiation to heat carbon black co-encapsulated in the hydrogel matrix with biomass was used to selectively heat biomass but not water in the treatment system. This selective heating technology enabled nearly complete ammonium removal and 89.4±4.3% TIN removal at influent temperature of 4° C. and reactor temperature 5° C. Activity tests suggested selective heating brought the biomass activity at influent temperatures of 4° C. and reactor temperature 5° C. to a level comparable to that at 10° C. Comammox and anammox were consistently present in the system and spatially organized in the hydrogel beads as revealed by qPCR and fluorescence in-situ hybridization (FISH). The abundance of comammox largely decreased by 3 orders of magnitude during the operation at 4° C., and rapidly recovered after the application of selective heating. The anammox-comammox technology tested in this example essentially enabled mainstream shortcut nitrogen removal, and the selective heating ensured good performance of the technology at temperature as low as 5° C.

Keywords: Comammox and anammox, Nitrogen removal, Mainstream Wastewater, Low Temperature, Direct Biomass Heating.

### Introduction

Partial nitritation-anaerobic ammonium oxidation (PN-anammox) provides a shortcut of nitrogen removal that significantly reduces the energy demand for aeration and requires no organic carbon source. However, previous PN-anammox processes have been mainly limited to side stream treatment (i.e., reject water from digesters) with high ammonium concentrations (500-1500 mg N/L) and high temperatures (25-35° C.), with little or no effective applications to mainstream wastewater, due at least in part to the low ammonium concentrations and low temperatures of mainstream wastewater.

The PN-anammox processes typically comprise two consecutive steps: ammonia-oxidizing bacteria (AOB) aerobically oxidize part of the incoming ammonium to nitrite (i.e., partial nitritation), which is then converted with the remaining NH₄⁺ to N₂ by anammox. The low ammonium concentration in mainstream wastewater is one of the factors limiting concomitant growth of AOB and anammox bacteria. It has been reported that nitrite production by AOB, rather than the anammox activity, can be the rate-limiting step in PN-anammox process. Moreover, the low temperature in mainstream wastewater (e.g., <10° C. in winter) can further reduce the biological activity of AOB. Therefore, new strategies are required to reliably supply nitrite to anammox bacteria under low ammonium and low temperature conditions.

Complete ammonia-oxidizing (comammox) Nitrospira species possess much higher affinity to ammonium (Km(app), NH₃≈63 nM), compared to conventional AOB (Km(app), NH₃>20 μM). This allows comammox to maintain activity and outcompete other ammonium oxidizers for ammonium in ammonia-limited environments, such as biofilms with limited diffusion rates and steep nutrient concentration gradients. Additionally, comammox has a relatively low affinity for nitrite, with a Km,NO₂ (449.2 μM for comammox Nitrospira inopinata) much lower than anammox strains (0.2-35.6 μM). Thus, anammox will outcompete comammox N. inopinata for the nitrite produced, but will not easily outcompete canonical Nitrospira, such as N. defluvii (one of the common NOB) which has a similar low Km,NO₂ of 9 μM. Comammox Nitrospira have been widely reported in natural and engineered environments, and water treatment systems. A practical application of comammox and anammox to mainstream wastewater treatment at low temperatures has not yet been achieved.

In cold climates, wastewater temperatures can fall below 10° C. and even reach 4° C. in extreme cases during the winter seasons. These low temperatures can limit the functional activity of wastewater treatment microbial communities, resulting in a loss of nitrogen removal. Heating mainstream wastewater is not economically feasible due to the tremendous energy demands. In contrast, biomass-targeted radiative heating controlled by a temperature feedback loop could maintain biological activity at a desired level without significantly heating the bulk wastewater. Water significantly absorbs radiation at wavelengths greater than 3,000 nm, but the radiation absorbance of water quickly decreases at wavelengths below 3,000 nm with minimum absorbance at wavelengths around 500 nm. Meanwhile, carbon black powder absorbs a significant amount of radiation at wavelengths between 200 to 2.500 nm. Therefore, co-immobilization of anammox and comammox with carbon black powder in hydrogels could allow selective heating of carbon black, and by extension catalytic biomass, with less energy loss due to unwanted direct heating of wastewater. Moreover, hydrogels provide a stable environment for the slow-growing commamox and anammox consortium, while allowing the retention of high-density biomass that improves the volumetric conversion rate of nitrogen species.

In this example, the comammox bacteria Nitrospira inopinata and anammox biomass were encapsulated along with carbon black into hydrogel beads, which were tested with both synthetic media and actual primary effluent of a municipal wastewater treatment plant (WWTP). Reactor performance at various temperature regimes (25, 16, 10 and 4° C.) was evaluated to assess nitrogen removal at real mainstream wastewater treatment temperatures. A novel radiation heating technology for heating biomass using carbon black while minimizing heat lost to water was designed and applied to successfully treat municipal wastewater at 4° C. in the influent and 5° C. in the reactor.

### Materials and Methods

### Preparation of Comammox and Anammox Biomass and Hydrogel Beads

Comammox Nitrospira inopinata was obtained and grown at 37° C. in the dark without agitation in HEPES buffered fresh water medium supplemented with 1 mM of ammonium. Growth was monitored by ammonium consumption as well as nitrite or nitrate accumulation. After ammonium depletion, 10% inoculum was transferred to fresh media, while the remaining culture was stored at 4° C. until further processing. 15 L of the collected comammox culture was concentrated to a final volume of 400 mL using a 30k Da tangential flow filtration cassette (Pellicon XL50) with Durapore 0.1 μm Membrane (MilliporeSigma, Burlington, USA).

Anammox biomass obtained from a WWTP in Rotterdam Sluisjesdijk, Netherlands, was maintained anaerobically in a plug-flow glass column supplied with a mineral media containing 1 mM NH₄⁺ and 1.3 mM NO₂⁻ at 30° C. in the lab for more than six months. Anammox granules were homogenized with a blender for 2 mins followed by 10-minute centrifugation at 3000 rpm. The biomass pellets were then resuspended in the concentrated comammox culture. The comammox-anammox mixture was screened using a sieve with pore size of 104 μm. 400 mL of the treated comammox-anammox slurry was used to prepare hydrogel beads, leading to a final 0.21 g volatile suspended solids (VSS)/L in the reactor. Biomass was encapsulated into 1.2 L of carbon black:polyvinyl alcohol-sodium alginate (PVA-SA) hydrogel beads with (w/v) 0.125% carbon black powder, 10% PVA and 1% SA, as described herein.

### Start-Up and Operation of the Reactor

A clear polycarbonate column reactor with a 3.5 L working volume (FIG. 14 and hydrogel bead 2 at FIG. 1C) was operated with a continuous feed with a hydraulic retention time (HRT) of 3.9 days and a biomass specific nitrogen loading of 0.037 kgN/gVSS/d at an estimated influent NH₄⁺—N of 30 mg/L. A programmed microcontroller (Arduino, Monza. Italy) controlled the DO with electric solenoid valves and an air pump with feedback from a FireSting®-O2 optical oxygen and temperature meter (Pyroscience, Aachen, Germany). Oxygen diffusion and liquid mixing were improved by recirculating liquid from the top to bottom of the reactor. The pH was monitored using a portable pH probe (ThermoFisher Scientific. Waltham, MA).

Prior to operation with wastewater, the hydrogel reactor was operated in the lab for 62 days with synthetic media containing no organic carbon source and no detectable COD. The temperature was controlled at 25° C. and DO of 0.2-0.3 mgO₂/L. During lab operation, the reactor was fed with synthetic wastewater containing NH₄⁺—N as the only nitrogen source and a mineral media as mentioned above. On day 62, the reactor was transported to the Everett WWTP (Everett, WA, USA) for onsite operation. Primary effluent of the WWTP was used as the influent of the reactor. From day 98, the reactor was operated in the lab, but still fed with primary effluent collected from the Everett WWTP. Equipment and operating conditions, including influent load and HRT, were kept constant to maintain consistency between the on-site operation and lab operation. Temperature was changed at different experimental stages as described below. DO was maintained at 0.2-0.3 mg/L in the reactor during operation from the beginning till the early stage of operation with radiative heating, day 1-day 185. DO was decreased to 0.1-0.2 mg/L during day 185-221 to suppress the activity of NOB which led to accumulation of nitrate in the reactor.

### Temperature Control and Selective Heating

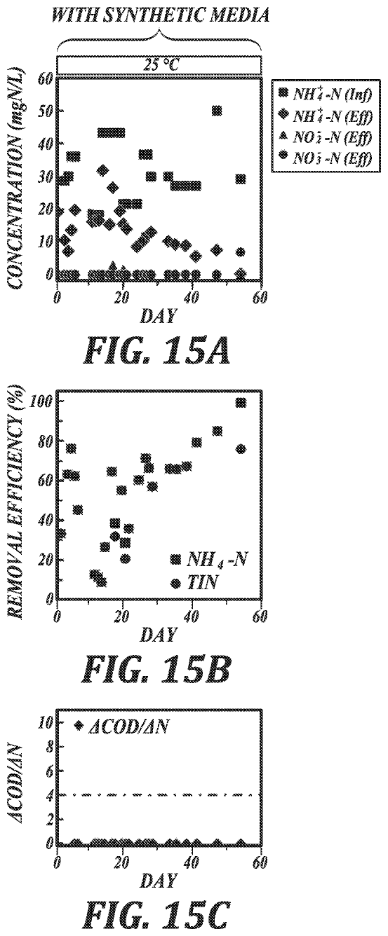

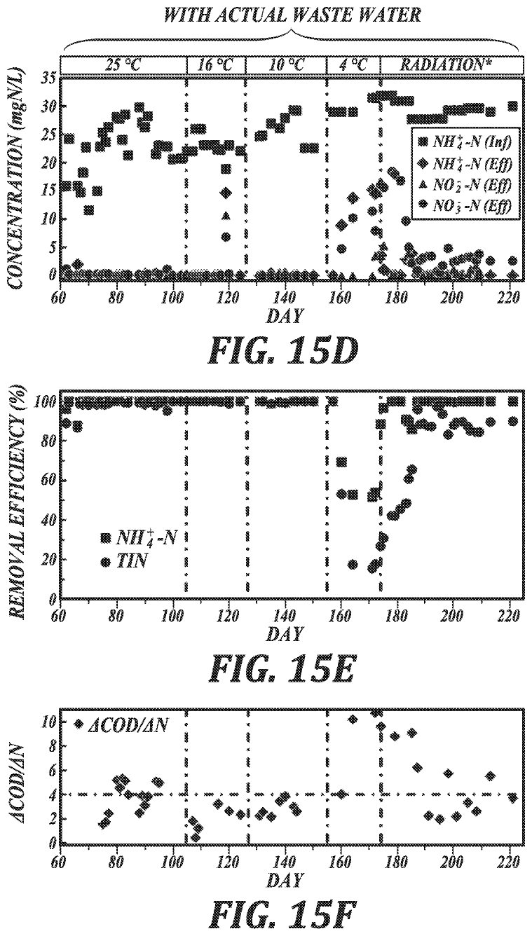

The reactor was sequentially operated at 25° C. (day 1-106), 16° C. (day 107-130), 10° C. (day 124-156) and 4° C. (day 157-172) to examine how temperature affects the nitrogen removal performance of the reactor (FIGS. 15A, 15B, 15C, 15D. 15E, and 15F). At 25° C., 16° C. and 10° C., the temperature was maintained by wrapping the reactor with tubes recirculating water from a ThermoTek T257P precision chiller (ThermoTek, Flower Mound, TX). At 4° C., the temperature was maintained by operating the reactor in a 4° C. temperature-controlled room.

A novel selective biomass heating method using infrared (IR 940 nm) radiative heating of hydrogel-encapsulated carbon black was developed and applied in this study from day 173-221 (referred as Radiation condition). This 940 nm wavelength was selected as it is weakly absorbed by water but efficiently absorbed by carbon black in the hydrogel beads, and it does not support phototrophic growth of, e.g., algae or cyanobacteria and purple bacteria. The selective heating equipment is comprised of two 100 W infrared (IR 940 nm) light-emitting diodes (LED) lamps (Chanzon, Shenzhen, China) mounted in reflectors with 60-degree lenses at the actual working electrical load of 48 watts. The LEDs were attached to fan-cooled heat sinks and powered by a constant current LED driver. The selective heating equipment was controlled by a PID temperature controller (InkBird, Shenzhen, China) with a setpoint of 5° C. based on the feedback of a thermal meter monitoring the temperature in the bulk liquid in the reactor. The reactor was wrapped with reflective foil insulation to reduce radiation loss (FIG. 14, “reflective surface”).

### Chemical Analytical Methods

NH₄⁺—N, NO₂⁻—N, and NO₃⁻—N in the daily influent and effluent of reactor were measured using a colorimetric method with a Gallery Automated Photometric Analyzer (ThermoFisher Scientific, Waltham, MA U.S.A.) following the manufacturer's protocol. Soluble chemical oxygen demand (sCOD) measurement was achieved using COD Digestion Vials-Low Range (Hach, Loveland, CO), following the Standard Method 5220 D. Total suspended solids (TSS) and VSS was analyzed following the Standard Method 2540.

### In-Situ Activity Tests

At the end of operation, the biomass activity of the reactor was tested by in-situ batch tests in triplicate at 25° C. 16° C., 10° C., 4° C., and Radiation. All tests were conducted within a span of 72 hours to exclude variation resulting from significant change in amount of biomass in the reactor. In in-situ activity tests, 500 mL of the primary effluent was fed into the reactor with no continuous influent or effluent pumping. Liquid samples were taken from the reactor every 30 mins for 3 hours to monitor the removal rate of NH₄⁺—N(rNH₄⁺—N) and TIN (rTIN) including NO₂⁻—N and NO₃⁻—N. DO was maintained at 0.2-0.3 mgO₂/L during the in-situ activity tests. The rNH₄⁺—N and rTIN per reactor was calculated by the Pearson correlation of concentrations and reaction time.

qPCR, Fluorescence In-Situ Hybridization (FISH) and Sequencing

Hydrogel beads were sampled from the reactor during all experimental phases. Hydrogel beads homogenized for 30 mins with a bullet blender (Next Advance, Troy, NY) pre-cooled with dry ice. DNA was then extracted using the Qiagen DNeasy PowerBiofilm Kit (Qiagen. Hilden, Germany) following the manufacturer's protocol. DNA was measured for concentration using the Qubit4 (Invitrogen, Waltham, MA) and stored at −20° C. until further analysis. qPCR was performed to quantify the abundances of (i) amoA of Ca. Nitrospira inopinata, (ii) amoA of AOB, (iii) 16S rRNA of anammox, (iv) nxrB of NOB, and (v) universal 16S rRNA using primers and PCR conditions listed in Table 1. The V4-V5 region of the 16S rRNA gene was amplified by PCR for next generation sequencing using 515F-Y/926R primers. Fluorescence In Situ Hybridization (FISH) of hydrogel beads was performed for analysis of anammox and Nitrospira. Suspended biomass was excluded from analysis due to the negligible VSS concentrations and total biomass amount (as indicated by 16S rRNA and DNA) compared to the hydrogel encapsulated biomass.

### Results

### 3.1 Reactor Performance

During the operation with synthetic media (day 1-61), the reactor showed a continuously improving nitrogen removal performance and reached an average removal efficiency of 87.9±7.5% for NH₄⁺—N and 80.1±6.6% for TIN in the last three weeks (day 40-61) (FIGS. 15A and 15B). No significant accumulation of nitrate was observed in the reactor. As there was no external COD available in the influent media to approve heterotrophic denitritation/denitrification (FIG. 15C), the reduction in NH₄⁺—N and TIN in the reactor indicated the stable nitritation and anammox activity.

During operation with actual wastewater as the feed (day 62-157), the reactor continued to show good nitrogen removal at 25° C., 16° C., and 10° C. (FIGS. 15D and 15E) with removal efficiencies of 99.6±0.3% for NH₄⁺—N and 98.9±0.9% for TIN. During day 158-173, when temperature was decreased to 4° C., NH₄⁺—N and TIN removal efficiencies decreased to 53.9% and 17.7% at the end of this experimental phase. Implementing the radiative heating technology led to an immediate recovery of NH₄⁺—N removal and a gradual recovery of TIN removal (FIGS. 15C and 15D). Radiative heating only minimally heated the water phase of the reactor with influent temperatures at 4° C. and bulk liquid temperatures of 5° C. (with a variation<±0.2° C.). During the initial recovery of activity (Day 173-185), nitrate was the major form of TIN due to excessive nitrite oxidizing activity. To reduce nitrite oxidation, the DO setpoint was decreased from 0.2-0.3 mg/L to 0.1-0.2 mg/L. Consequently, TIN removal recovered and stabilized at 89.4±4.3%.

During the operation of reactor fed with actual wastewater, the nitrogen removal performance was not affected by the influent COD condition. TIN was completely removed with ΔCOD/ΔN less than 4 in most cases, which is not sufficient to support denitrification, and also with ΔCOD/ΔN less than 2.5 in some cases, which is not sufficient to support denitration (FIG. 15F). During the operation at 4° C. and beginning of the radiation condition (Day 158-185), the COD removal was not affected while the TIN removal dropped followed by obvious nitrate accumulation, resulting in high ΔCOD/ΔN during that period. Without wishing to be bound by any particular theory, the removal of COD independent from the TIN may indicate that COD was not primarily removed by the denitrifiers but other microbes, and it can be concluded that anammox was the major process for nitrogen removal.

### 3.2 Nitrogen Removal Activity in In-Situ Activity Tests

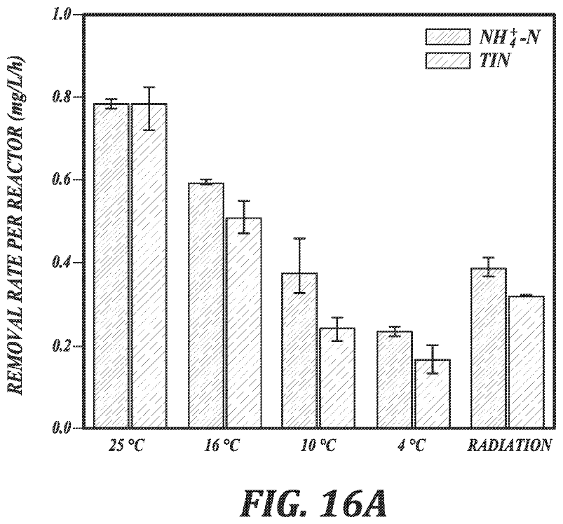

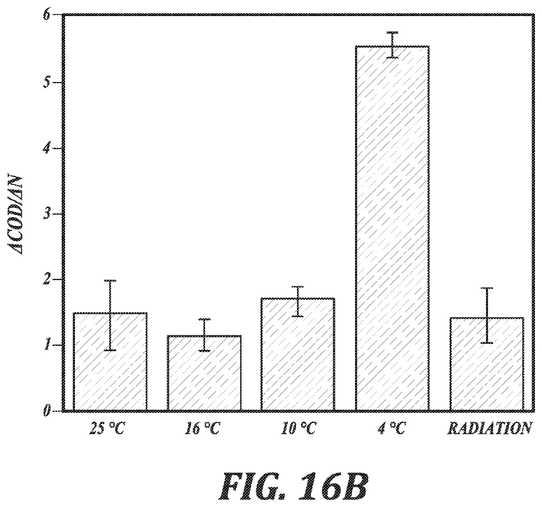

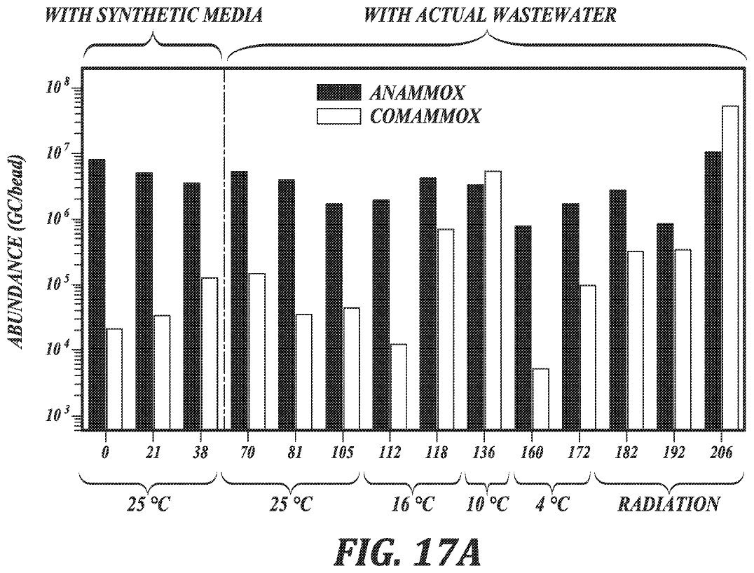

In-situ activity tests showed that decreasing temperatures from 25° C. to 4° C. reduced removal rates of NH₄⁺—N(rNH₄⁺—N) and TIN (rTIN) (FIGS. 16A and 16B). Compared with NH₄⁺—N, the TIN removal rate was more affected by the lower temperature (Anovatest, P<0.05). The TIN reaction rates decreased by 35.1%, 69.1% and 78.9% at 16, 10 and 4° C. respectively compared with the activity at 25° C., while the NH₄⁺—N reaction rate decreased by smaller increasements of 24.3%, 51.7% and 70.0% at 16, 10 and 4° C., respectively, compared with that at 25° C. Selective biomass heating through radiation (Radiation) significantly increased rNH₄⁺—N and rTIN (1.6 and 1.9-fold respectively) compared to 4° C. Biomass activity at the Radiation condition was more similar to the observed activities at 10° C. (the same or 1.3-folds of rNH₄⁺—N and rTIN compared to 10° C.), suggesting biomass temperature may have been around or above 10° C., despite influent temperature of 4° C. in the bulk liquid temperature of 5° C. Given the initial encapsulated biomass concentration of 0.21 g VSS/L, the biomass specific removal rates were 0.090, 0.068, 0.043, 0.044 g NH₄⁺—N/d/gVSS and 0.090, 0.058, 0.028 and 0.037 g TIN/d/g VSS, at 25° C., 16° C., 10° C. and radiation condition. These rates were comparable or higher than other reported values in anammox reactors for mainstream wastewater treatment. For example, previous studies reported specific removal rates of 0.005-0.016 g NH₄⁺—N/d/gVSS at 20-25° C. and 0.03 to 0.07 gTN/gVSS/d at 25° C. for PN-anammox reactors. With assuming a VSS concentration of 2 g VSS/L with the same specific removal rate and influent condition of this example, the HRT would need to be ~4 h for a scaled-up reactor to achieve the same nitrogen removal performance at 25° C.

Although denitrifiers could also contribute to the nitrogen removal, the low ΔCOD/ΔTIN in the activity tests (FIG. 16B) suggests that Anammox, but not denitrification, must have been the major metabolism for nitrogen removal. Assuming that COD was used for denitrification (and not aerobic respiration) and assuming that the remaining nitrogen was removed via Anammox, mass balance indicated that Anammox contributed 62.7±13.3%, 71.2±6.0%, 57.1±6.0%, 75.9±23.4% of total nitrogen removal at 25° C., 16° C., 10° C., and the Radiation condition, respectively.

### 3.3 Growth and Spatial Distribution of Anammox and Comammox

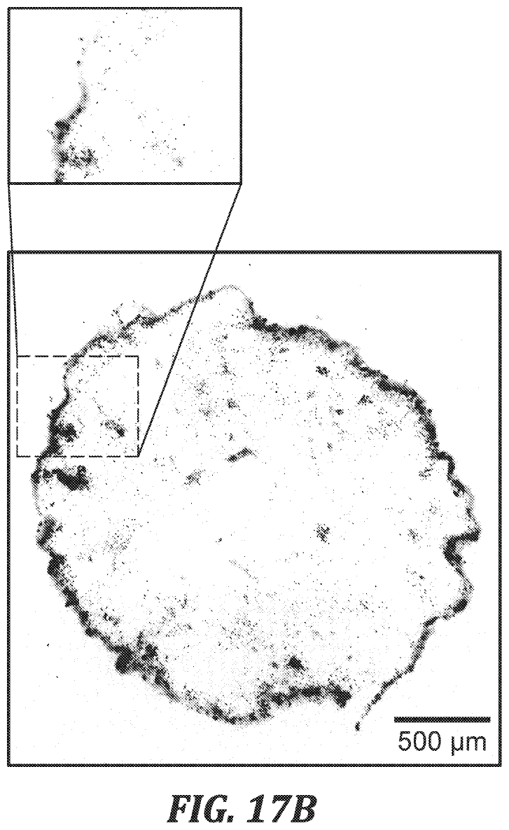

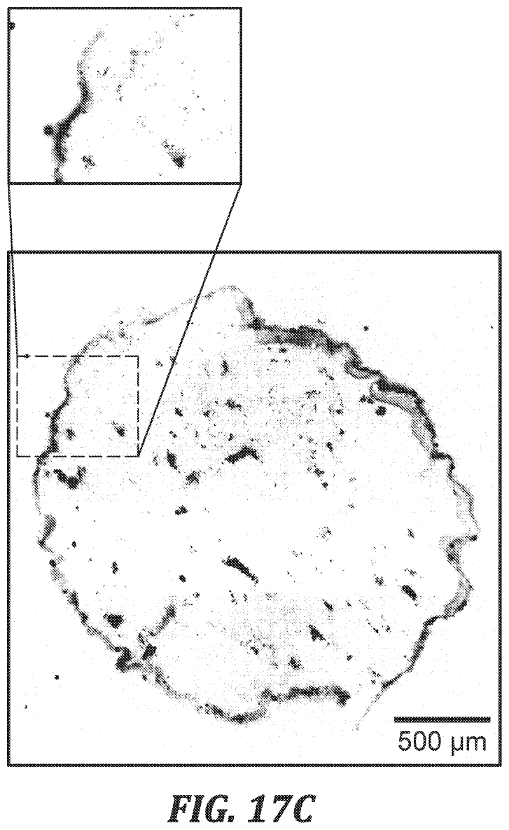

Results from qPCR revealed that comammox and anammox bacteria were abundant in the reactor throughout entire operation (FIG. 17A), confirming that the low influent NH₄⁺—N favored the concomitant growth of anammox and comammox in this example. Anammox abundance remained relatively stable in the system at all temperature regimes, while comammox abundance generally increased throughout operation, until day 160 which corresponded with a temperature decreased to 4° C. on day 157. When the reactor temperature decreased from 10° C. to 4° C., the abundance of comammox decreased by 3 orders of magnitude, while anammox abundance remained relatively stable (FIG. 17A). In addition, the lack of nitrite production by comammox decreased the removal of both NH₄⁺—N and TIN at 4° C. (Day 157-172). These results suggest that aerobic ammonia oxidizers can be the bottleneck of PN-anammox systems rather than anammox bacteria. Comammox was able to adjust to lower temperatures, as abundances increased again towards the end of 4° C. phase. However, comammox only fully recovered after applying direct heating, resulting in rapidly increased abundances, supporting the recovered daily nitrogen removal during the operation after implementation of radiation heating (FIG. 17A).

FISH imaging of the hydrogel beads confirmed the presence and abundance of anammox and Nitrospira (comammox or canonical Nitrospira). Additionally, microscopic imaging demonstrated the evolution of these guilds' spatial organization in the hydrogel beads throughout the experiments (FIGS. 17B and 17C). While comammox and anammox were both present throughout the beads, anammox (i.e., FITC channel shown in FIG. 17C) tended to be more abundant in the low-oxygen inner core while Nitrospira (i.e., Cy3 channel shown in FIG. 17B) were more abundant in the oxygenated periphery of the hydrogels. This spatial distribution pattern of comammox in the outer and anammox in the inner region of the hydrogel beads was observed consistently during the entire operation.

### 3.4 Changes in Microbial Community

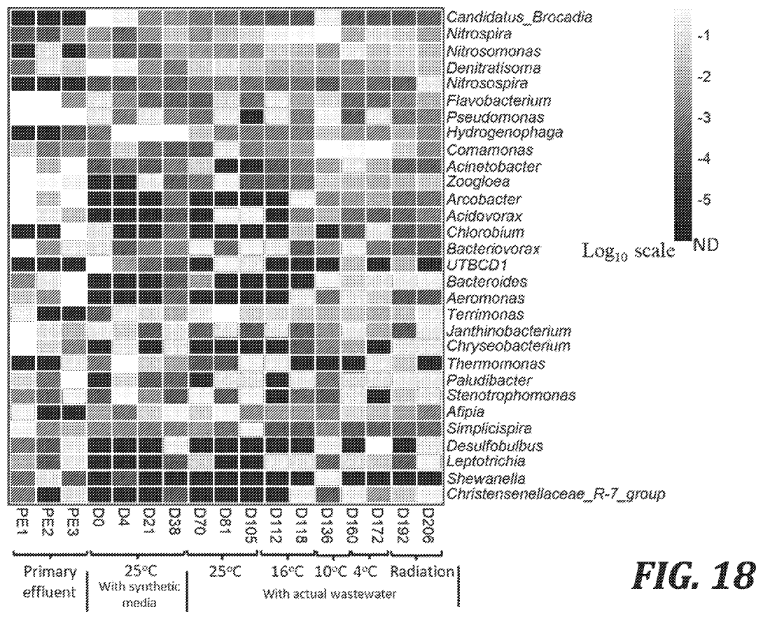

16S rRNA gene sequencing revealed a relatively consistent microbial community in the hydrogel beads that was distinct from the influent microbial community. An NMDS plot with Bray-Curtis dissimilarity distances showed a cluster of the amplicon sequencing variants from hydrogel beads excluding influent samples. Heatmap of the top 30 genera (FIG. 18) also revealed the consistent major genera in the hydrogel beads during the operation, differing from those in the influent (primary effluent of WWTP). These results indicate that the hydrogel encapsulation can effectively retain the encapsulated microbial community and limit contamination and competition from the external medium. In alignment with the qPCR results, anammox and Nitrospira were found to thrive in the hydrogel beads across the entire operation of the reactor as shown by 16S rRNA sequencing (FIG. 18). Ca. Brocadia was the only detected anammox genus. Nitrospira ASVs contained both canonical NOB-Nitrospira and comammox Nitrospira. Specifically, the major Nitrospira-ASVs (with sequence reads no less than 5) were aligned to the expected PCR amplicon of the 16S rRNA sequences of five canonical Nitrospira and three comammox Nitrospira strains by local blastN, and it was found that the dominant ASVs in hydrogel beads showed highest identity to either N. inopinata (the Comammox used to seed the reactor) or N. defluvii (the canonical Nitrospira that exists in the seed anammox sludge) with identity of 97.8-100%. N. defluvii was the only detected Nitrospira in the primary effluent. Presence of AOB (Nitrosomonas and Nitrosospira) and denitrifying bacterial genus (Denitratisoma) were also detected by the 16S sequencing (FIG. 18).

### Discussion

### 4.1 Integrating Anammox-Comammox for Mainstream Nitrogen Removal

In this study, comammox and anammox were encapsulated in hydrogel beads for treatment of both synthetic and actual municipal wastewater and demonstrated long-term effective nitrogen removal, even at low temperatures. The reactor achieved almost complete removal of both NH₄⁺—N and TIN at temperatures as low as 10° C., with nearly undetectable effluent NH₄⁺—N and TIN concentrations.

Without wishing to be bound by any particular theory, the low effluent nitrogen concentration in this example could be attributed to the higher affinity of comammox for ammonium (Km(app), NH₃≈63 nM) compared to canonical AOB (Km(app), NH₄>20 μM), allowing comammox to thrive at ammonium-depleted conditions, and there can also be an advantage of commamox over AOB in the low ammonium condition. Although the oxygen affinity of comammox has yet to be measured, theoretical predictions and genomic studies suggest that comammox Nitrospira likely have a high oxygen affinity and are adapted to environments with low DO as harboring cytochrome bd-like oxidases. The predicted high oxygen affinity of comammox and oxygen-gradient in hydrogel beads were useful for the comammox-anammox partnership to perform in low oxygen requirements. An operational DO<0.2 mg O₂/L was sufficient for complete ammonium removal by comammox. The ability of comammox to function at a low oxygen concentration also likely protected anammox from oxygen inhibition hence allowing high rate one-stage PN-anammox, which has not been reported in AOB-anammox systems. In contrast, the poor oxygen affinity of AOB requires higher aeration to ensure sufficient nitrite supply, while this high aeration could give NOB a competitive edge over anammox as well as inhibit anammox through deeper oxygen penetration. The qPCR results also demonstrate the preferential growth of comammox and anammox over AOB and NOB, with average comammox/AOB and anammox/NOB ratio of 108 and 125 during the study.

In this example, hydrogel encapsulation was implemented to effectively retain slow-growing comammox and anammox (FIGS. 17A, 17B, and 17C), enabling effective nitrogen removal (FIGS. 15A, 15B, 15C, 15D, 15E, and 15F). The hydrogel encapsulation of pre-enriched biomass allows for a rapid process start-up (FIG. 17A), much faster than the start-up by forming natural granules or biofilm which typically requires months or even years. Hydrogel encapsulation also imposes diffusion limitations, which combined with aerobic activity creates oxygen gradients. This provides favorable niches for both aerobic comammox and oxygen-sensitive anammox (FIGS. 17A. 17B, and 17C). Moreover, the hydrogel encapsulation also possesses the advantage of allowing for encapsulating beneficial additives with the biomass, for example the additive of carbon black powder to enhance the radiation absorbance (see, e.g., hydrogel bead 2 of FIG. 1C) used, which can also be combined with other beneficial additives such as growth promoting chemicals for comammox or anammox.

### 4.2 Effects of COD and Denitrification on the System

Except experimental phase at 4° C. and the subsequent recovering period, efficient nitrogen removal was achieved ignoring the presence/absence of influent concentration of COD (FIGS. 15A, 15B, 15C, 15D, 15E, and 15F), indicating that the influent COD had no obvious effect on the nitrogen removal. In alignment with the commonly observed COD reduction in PN-anammox systems, COD removal with an average efficiency of 72.5±19.8% was also observed in this study. Certain levels of COD can benefit the PN-anammox systems by favoring the enrichment of anammox bacteria and facilitating the combination of partial denitrification and anammox. The nitrogen reduction and anammox bacteria abundance both increased along with the increasing COD/N from 1.1 to 2.5 in a PN-anammox system under intermittent aeration. However, the independence of COD removal from nitrogen removal (good COD removal at low temperature when nitrate accumulated), and the low ΔCOD/ΔN in batch test (FIGS. 16A and 16B) and in most cases during long-term operation, together suggests heterotrophic denitrification was not the primary driver for nitrogen removal.

As exemplified by the spatial distribution of comammox and anammox (FIGS. 17B and 17C) within the hydrogel beads, the mass transfer limitation of oxygen allowed for aerobic and anaerobic niches, enabling the co-existence of oxygen-dependent and fermentative reactions, such as denitrification, acidogenesis, as well as methanogenesis, contributing to COD removal. 16S sequencing data revealed the co-occurrence of heterotrophs with aerobic or/and anaerobic traits, such as Flavobacterium, Denitratisoma, Pseudomonas (FIG. 18) in the beads. Methanogens were also frequently detected in the hydrogel beads. Integration of methanogens promoted the COD removal in a PN-anammox system, and moreover. Nitrospira exhibits a high metabolic versatility and can grow anaerobically on organic carbon while respiring nitrate. Nitrospira and anammox can both undertake dissimilatory nitrate reduction to ammonium (DNRA) utilizing organic matter with nitrate as the electron acceptor. Given that heterotrophic growth has a high biomass yield while the Nitrospira respiration. DNRA, and anaerobic COD removal have lower yield, a system dominated by ordinary heterotrophs would produce a significant amount of biomass. The low planktonic VSS and also the relatively stable DNA amount of hydrogel encapsulated biomass together indicated a low biomass yield in this example. Therefore, it is likely that COD was removed by the combined functioning of multiple microbes, including Nitrospira, anammox, comammox, methanogens, and also denitrifiers, rather than ordinary heterotrophs or denitrifiers alone.

### 4.3 Effects of Temperature and Selective Biomass Heating

A major challenge in the application of PN-anammox to mainstream treatment is the low temperatures of mainstream wastewater. Targeting this challenge, the reactor was operated at a broad temperature range from 25 to 4° C. Notably, lower temperatures usually result in deteriorated performance of anammox-based engineered systems; previous work observed significant decreases in reactor performance of PN-anammox at 10-15° C. The encapsulated comammox-anammox community resisted loss of function at the low temperatures better than in previously reported studies in that good performance was observed at temperature down to 10° C. and severely deteriorated performance was only observed at 4° C. (FIGS. 15A, 15B, 15C, 15D, 15E, and 15F). Although anammox was abundant at low temperatures (FIGS. 17A. 17B, and 17C), the nitrogen removal was affected as the observed drop in comammox abundance resulted in a lack of nitrite supply. These results can suggest that the supply of nitrite to anammox by nitrifiers is a bottle neck for PN-anammox at low temperatures.

To ensure good nitrogen removal performance at temperatures below 10° C., a novel direct heating technology was tested which radiatively heats carbon black co-encapsulated with comammox-anammox in hydrogels. Selecting a wavelength of 940 nm simultaneously minimizes unwanted radiation absorbance by water (minimum absorbance near 500 nm), while limiting phototrophic growth (e.g., algae utilize light up to 800 nm and purple bacteria mainly utilize light up to 875 nm). A preliminary experiment with an unfocused light source with peak emission in the 700-1000 nm range resulted in excessive growth of algae and failure of the reactor, while a focused light at ~940 nm did not support phototrophic growth. After the implementation of the selective heating, biomass activity rapidly recovered despite low influent (4° C.) and bulk liquid (5° C.) temperatures. Both ammonium and TIN removal eventually fully recovered after applying radiative heating (FIGS. 15A, 15B. 15C. 15D, 15E, and 15F). This recovery happened immediately after the implementation of radiation heating, indicating it was a result of the increased temperature of the biomass promoting the reaction rate, rather than dynamics in the amount of biomass or microbial community via growth which would require more time. The in-situ activity tests showed removal rates of ammonium and TIN under Radiation comparable to those at 10° C. (FIGS. 16A and 16B), indicating a temperature increase within the hydrogel beads but not in the bulk liquid (5° C.).

Notably, there was nitrate accumulation during at 4° C. and also the recovery period of nitrogen removal after implement of radiation, and this is consistent with a higher resilience of NOB to low temperature than anammox and AOB, leading to increased nitrate accumulation. Since the NOB possesses lower oxygen affinity than comammox, the oxygen set point was reduced from 0.2-0.3 mg/L to 0.1-0.2 mg/L (starting from day 185) to suppress the activity of NOB, which rapidly eliminated the accumulation of nitrate. This change to the oxygen concentration level did not weaken the effectiveness of the radiative heating as the rapid recovery in ammonia and TIN removal was observed before reducing the oxygen setpoint (day 172-185), with a removal efficiency of ~100% and 65.6% on day 185 respectively. The absence of ammonia and accumulation of nitrite at current oxygen level (0.2-0.3 mg/L) was more than sufficient for full nitrification. The recovered TIN removal efficiency at the lower oxygen setpoint could not be attributed to an increase in the denitrification/denitritation rate, as the low ΔCOD/ΔN in batch test indicated the limited denitrification/denitritation activity in the reactor. By reducing the oxygen setpoint to 0.1-0.2 mg/L, successful NOB suppression was observed with a TIN removal efficiency of 90.0% at the end of the operation.

### 4.4 Impact, Application, and Further Exploration

The comammox-based PN-anammox reactor in this example demonstrated constant and nearly complete nitrogen removal at temperatures down to 10° C., enabling application of this technology in most climates and under even the strictest policies, or environmental requirements. This example also used primary municipal wastewater indicating the practical application of this technology to actual mainstream treatments. The hydrogel encapsulation of biomass in this example also allowed for the instantaneous formation of synthetic biogranules and rapid start-up of the systems compared with the typically long process of natural forming anammox granules. The novel heating technology of selective heating for biomass allows for greater process resilience by enabling high nitrogen removal at extremely low water temperatures. In addition, one could optimize the energy utilization in this system by adjusting the intensity of radiation and the size (volumetric surface ratio) of the hydrogel beads to reduce heat loss from the biomass to the bulk fluid.

The hydrogel encapsulation of biomass in this example also allows for the instantaneous functioning of the systems compared with the typically long process of natural forming anammox granules or other types of biofilm systems. The novel heating technology of selective heating for biomass allows for the high nitrogen removal performance at extremely low water temperature. For engineered systems, radiative heating can be achieved with submerged waterproof LEDs which are commercially available. In some climate zones principles of passive solar design could be applied to take advantage of free solar heating since roughly half of solar radiation falls in the IR range. For instance, by using reflective surfaces optimally angled for winter and IR-selective panes to create solar gain, possibly in combination with light guides made of polyethylene terephthalate plastic from recycled soda bottles and filled with clean water to enhance the penetration depth of the collected warming radiation. Further optimization of energy utilization with LED can be implemented. At steady state, the energy of heating is mainly used to compensate the heat loss via the warmed-up effluent. An estimated energy demand of the radiation heating in this example is 8846 kWh per million gallons (MG) compared with the average energy demand of 3,200-3,600 kWh/MG for public water and wastewater service, which does not include heating, in the United States. Since existing public water and wastewater services are at risk of disruption at lower temperatures (e.g., less than about 10° C.), which can result in poor effluent quality, fines, and imposed penalties, there is a need for relatively cost-efficient systems and methods for heating to maintain bioactivity, prevent disruption, and avoid disruption-related costs. Accordingly, energy consumption of the disclosed systems including heating elements is practical, especially considering that heating is only needed occasionally at extremely low temperatures and these energy costs can offset the costs required to be paid for effluent violations. In addition, implementations for optimization of energy utilization for heating can enhance heat absorbance by biomass and include better temperature control, more additives for enhancing radiation absorbance, and optimized size (e.g., volumetric surface) of hydrogel beads which affects the heat diffusion between the beads and surrounding bulk liquid.

### CONCLUSIONS

Here, comammox and anammox were co-encapsulated in hydrogel beads to develop a new generation of one-stage PN-anammox systems that can completely remove nitrogen from actual mainstream municipal wastewater at operational temperatures down to 10° C. The co-encapsulation of carbon black with catalytic biomass in the hydrogel matrix also enabled application of a novel radiation-based selective heating technology to selectively heat biomass without excessive energy loss to the bulk liquid phase. This approach further extended the range of operational temperatures down to 4° C. Together, this example provides a widely applicable and scalable approach to drastically improve nitrogen removal from domestic wastewater with lower energy inputs and area requirements than currently available technologies.

### NON-LIMITING EMBODIMENTS

While general features of the disclosure are described and shown and particular features of the disclosure are set forth in the claims, the following non-limiting embodiments relate to features, and combinations of features, that are explicitly envisioned as being part of the disclosure. The following non-limiting Embodiments contain elements that are modular and can be combined with each other in any number, order, or combination to form a new non-limiting Embodiment, which can itself be further combined with other non-limiting Embodiments.
Embodiment 1. A hydrogel matrix configured for bioremediation by a process, the hydrogel matrix comprising: an aerobic ammonium oxidizer (AOO) selected from the group consisting of: an ammonium oxidizing bacterium, an ammonium oxidizing archaeon, a complete ammonium oxidizing (comammox) bacterium, or any combination thereof; and an anaerobic ammonia oxidizing (Anammox) bacterium.
Embodiment 2. The hydrogel matrix of Embodiment 1, wherein the Anammox bacterium is positioned toward an interior of the hydrogel matrix and the AOO is positioned toward an exterior of the hydrogel matrix.
Embodiment 3. The hydrogel matrix of any of Embodiments 1-2, wherein the hydrogel matrix is configured as a hydrogel bead.
Embodiment 4. A device for bioremediation, the device comprising the hydrogel matrix of any of Embodiments 1-3.
Embodiment 5. The device of Embodiment 4, further comprising an infrared light heat element, or radiative heat element, that is configured to irradiate carbon black that is encapsulated within the hydrogel matrix to warm the hydrogel matrix and facilitate the process.
Embodiment 6. The device of any of Embodiments 4-5, wherein with operation of the device, total nitrogen of an effluent of a bulk liquid of the device is decreased.
Embodiment 7. The device of any of Embodiments 4-6, further comprising: a hollow fiber membrane, positioned within an interior of the device, that comprises an interior that is fluidly connectible with air and an exterior with a biofilm coating thereon that comprises, for a partial nitrification/anammox (PN/anammox) process, an Anammox bacterium, an ammonium-oxidizing archaea (AOA), an ammonium-oxidizing bacterium (AOB), a nitrite-oxidizing bacterium (NOB), a comammox bacterium, or any combination thereof.
Embodiment 8. The device of any of Embodiments 4-7, further comprising a heat element configured to warm the hollow fiber membrane, the hydrogel matrix, a bulk liquid of the device, or any combination thereof to facilitate the PN/anammox process, the process, or both.
Embodiment 9. A device for resource recovery, the device comprising: a hollow fiber membrane, positioned within an interior of the device, that comprises an interior that is fluidly connectible with CO₂ and H₂ gas and an exterior with a biofilm coating thereon that comprises, for a CH₄ production process, a hydrogenotrophic methanogen.
Embodiment 10. The device of Embodiment 9, wherein the hydrogenotrophic methanogen is disposed with a hydrogel coating that replaces or supplements extracellular polymeric substances (ESP) produced by the hydrogenotrophic methanogen and increases conversion of CO₂ and H₂ to CH₄ by the hydrogenotrophic methanogen.
Embodiment 11. The device of any of Embodiments 9-10, wherein the hydrogenotrophic methanogen comprises a species of Methanobacteria, a species of Ca. Methanofastidiosum, a species of Methanosaeta, a species of Methanolinea, or any combination thereof.
Embodiment 12. The device of any of Embodiments 9-11, further comprising a CH₄ sensor positioned at a gas exhaust of the device for measurement of methane produced by the hydrogenotrophic methanogen of the device at the gas exhaust.
Embodiment 13. The device of any of Embodiments 9-12, wherein CH₄ produced by the hydrogenotrophic methanogen is used as an energy source for wastewater treatment, by a nitrate/nitrite dependent methane oxidizer for denitrification in a bulk liquid of the device, as an energy source for industrial use, as an energy source for consumer use, or any combination thereof
Embodiment 14. The device of any of Embodiments 9-13, wherein CH₄ produced by the hydrogenotrophic methanogen is used as an energy source for a methanotroph utilizing oxygen from a bulk liquid, within the interior of the device, to produce CH₃OH, poly-ß-hydroxybutyrate (PHB), or both; the device optionally further comprising a nitrate/nitrite dependent methane oxidizer.
Embodiment 15. A device for bioremediation or resource recovery, the device comprising: a hollow fiber membrane positioned within an interior of the device, wherein the hollow fiber membrane comprises an interior that is fluidly connectible with a gas and an exterior with a biofilm coating thereon that comprises a first microorganism, wherein the hollow fiber membrane is permeable to at least one molecule of the gas that is utilizable by the first microorganism for a first process that comprises an aerobic process; and a second microorganism positioned at an outer layer of the biofilm coating, within a bulk liquid that is in fluid contact with the biofilm coating, encapsulated within a hydrogel matrix within the bulk liquid, or any combination thereof; wherein the second microorganism is for a second process that comprises an anaerobic process.
Embodiment 16. The device of Embodiment 15, wherein with bioactivity of microorganisms on the hollow fiber membrane, an inner layer of the biofilm coating has a higher concentration of O₂ and an outer layer of the biofilm coating has a lower concentration of O₂.
Embodiment 17. The device of any of Embodiments 15-16, wherein the first process removes NH₄⁺, total inorganic nitrogen (TIN), or both from a bulk liquid of the interior of the device, wherein the bulk liquid is in fluid contact with the biofilm coating.
Embodiment 18. The device of any of Embodiments 15-17, wherein the first microorganism comprises an AOA, an AOB, a comammox, a NOB, or any combination thereof.
Embodiment 19. The device of any of Embodiments 15-18, wherein the AOA comprises a species of the Nitrososphaera genus or N. viennensis.
Embodiment 20. The device of any of Embodiments 15-19, wherein the NOB comprises Nitrospira defluvii, a different species of the Nitrospira genus, complete ammonium oxidizing bacteria (comammox), a species that is capable of complete ammonium oxidation via formation of nitrite as an intermediate, or any combination thereof
Embodiment 21. The device of any of Embodiments 15-20, wherein the anaerobic process removes NH₄⁺, organics, or both from the bulk liquid.
Embodiment 22. The device of any of Embodiments 15-21, wherein the second microorganism comprises an anaerobic ammonium oxidation (Anammox) bacterium.
Embodiment 23. The device of any of Embodiments 15-22, wherein the Anammox bacterium comprises a species of Ca. Brocadia, a species of Ca. Kuenenia, a species of Ca. Scalindua, a species of Ca. Anammoxoglobus, a species of Ca. Jettenia, or any combination thereof
Embodiment 24. The device of any of Embodiments 15-23, wherein the Anammox bacterium comprises a species of Ca. Brocadia.
Embodiment 25. The device of any of Embodiments 15-24, further comprising a DO controller operably connected to a DO probe and an aeration valve for actuation of the aeration valve and adjustment of rate of aeration of the hollow fiber membrane based on a DO reading from the DO probe, such that the outer layer of the biofilm coating and the bulk liquid are maintained as at least mostly anaerobic for the anaerobic process.
Embodiment 26. The device of any of Embodiments 15-25, wherein actuation of the aeration valve and adjustment of rate of aeration of the hollow fiber membrane are performed manually by an operator or automatically by the DO controller.
Embodiment 27. The device of any of Embodiments 15-26, further comprising an influent pump fluidly connected to the interior of the device and configured to pump wastewater into the interior of the device.
Embodiment 28. The device of any of Embodiments 15-27, further comprising a mechanical mixer or a mixing gas inlet fluidly connected to the interior of the device and configured to deliver N₂ gas into the interior of the device.
Embodiment 29. The device of any of Embodiments 15-28, wherein the device is operational within a wide temperature range, is deployable to cold climates, and produces less bacterial biosolids compared to a previous device.
Embodiment 30. The device of any of Embodiments 15-29, wherein the wide temperature range includes the range of 10-25° C., or a portion thereof.
Embodiment 31. The device of any of Embodiments 15-30, wherein the second microorganism comprises an Anammox bacterium.
Embodiment 32. The device of any of Embodiments 15-31, further comprising: a third microorganism, either as at least part of an anaerobic digester sludge or as an acetogenic methanogen, that is encapsulated within a hydrogel matrix within the bulk liquid; wherein the third microorganism is for an anaerobic process that removes carbon from the bulk liquid and prevents biofouling of the device by a heterotroph.
Embodiment 33. A method for bioremediation, the method comprising: contacting a bulk liquid with a hollow fiber membrane that comprises an interior that is fluidly connectible with air and an exterior with a biofilm coating thereon that comprises a first microorganism that comprises a comammox, an AOA, an AOB, a NOB, or any combination thereof; wherein the hollow fiber membrane is permeable to O₂ of the air that is utilizable by the first microorganism for a first process that comprises an aerobic process.
Embodiment 34. The method of Embodiment 33, wherein the AOA comprises a species of the Nitrososphaera genus or N. viennensis.
Embodiment 35. The method of any of Embodiments 33-34, wherein the NOB comprises Nitrospira defluvii, a different species of the Nitrospira genus, complete ammonium oxidizing bacteria (comammox), a species that is capable of complete ammonium oxidation via formation of nitrite as an intermediate, or any combination thereof.
Embodiment 36. The method of any of Embodiments 33-35, the method further comprising: contacting the bulk liquid with a hydrogel matrix comprising an Anammox bacterium, an AOO, or both for an anaerobic process.
Embodiment 37. The method of any of Embodiments 33-36, wherein the hydrogel matrix comprises the Anammox bacterium and the AOO, wherein the Anammox bacterium is positioned toward an interior of the hydrogel matrix and the AOO bacterium is positioned toward an exterior of the hydrogel matrix.
Embodiment 38. The method of any of Embodiments 33-37, the method further comprising: contacting the bulk liquid with a hydrogel matrix comprising a third microorganism, either as at least part of an anaerobic digester sludge or as an acetogenic methanogen, that is encapsulated within a hydrogel matrix within the bulk liquid: wherein the third microorganism is for an anaerobic process that removes carbon from the bulk liquid and prevents biofouling of the device by a heterotroph.
Embodiment 39. The method of any of Embodiments 33-38, the method further comprising: monitoring the bulk liquid for DO, pH, and influent/effluent NH₄⁺—N, NO₂⁻—N and NO₃⁻—N concentrations; and aerating the interior of the hollow fiber membrane with air based on real-time ammonium loading and oxygen demand of microorganisms.
Embodiment 40. The method of any of Embodiments 33-39, wherein the method is configured to be performed within a wide temperature range, and produces less bacterial biosolids compared to a previous device.
Embodiment 41. The method of any of Embodiments 33-40, wherein the wide temperature range includes the range of 10-25° C. or a portion thereof.

While illustrative embodiments have been illustrated and described, it will be appreciated that various changes can be made therein without departing from the spirit and scope of the invention.

1-14. (canceled)

15. A device for bioremediation or resource recovery, the device comprising:
a hollow fiber membrane positioned within an interior of the device, wherein the hollow fiber membrane comprises an interior that is fluidly connectible with a gas and an exterior with a biofilm coating thereon that comprises a first microorganism, wherein the hollow fiber membrane is permeable to at least one molecule of the gas that is utilizable by the first microorganism for a first process that comprises an aerobic process; and
a second microorganism positioned at an outer layer of the biofilm coating, within a bulk liquid that is in fluid contact with the biofilm coating, encapsulated within a hydrogel matrix within the bulk liquid, or any combination thereof; wherein the second microorganism is for a second process that comprises an anaerobic process.

16. The device of claim 15, wherein with bioactivity of microorganisms on the hollow fiber membrane, an inner layer of the biofilm coating has a higher concentration of O₂ and an outer layer of the biofilm coating has a lower concentration of O₂.

17. The device of claim 15, wherein the first process removes NH₄⁺, total inorganic nitrogen (TIN), or both from a bulk liquid of the interior of the device, wherein the bulk liquid is in fluid contact with the biofilm coating.

18. The device of claim 15, wherein the first microorganism comprises an ammonium-oxidizing archaea (AOA), an ammonium-oxidizing bacterium (AOB), a comammox, a nitrite-oxidizing bacterium (NOB), or any combination thereof.

19. The device of claim 18, wherein the AOA comprises a species of the Nitrososphaera genus or N. viennensis.

20. The device of claim 18, wherein the NOB comprises Nitrospira defluvii, a different species of the Nitrospira genus, complete ammonium oxidizing bacteria (comammox), a species that is capable of complete ammonium oxidation via formation of nitrite as an intermediate, or any combination thereof.

21. (canceled)

22. The device of claim 15, wherein the anaerobic process removes NH₄⁺, organics, or both from the bulk liquid and wherein the second microorganism comprises an anaerobic ammonium oxidation (Anammox) bacterium.

23. The device of claim 22, wherein the Anammox bacterium comprises a species of Ca. Brocadia, a species of Ca. Kuenenia, a species of Ca. Scalindua, a species of Ca. Anammoxoglobus, a species of Ca. Jettenia, or any combination thereof.

24. The device of claim 23, wherein the Anammox bacterium comprises a species of Ca. Brocadia.

25. The device of claim 15, further comprising a dissolvable oxygen (DO) controller operably connected to a DO probe and an aeration valve for actuation of the aeration valve and adjustment of rate of aeration of the hollow fiber membrane based on a DO reading from the DO probe, such that the outer layer of the biofilm coating and the bulk liquid are maintained as at least mostly anaerobic for the anaerobic process.

26. The device of claim 25, wherein actuation of the aeration valve and adjustment of rate of aeration of the hollow fiber membrane are performed manually by an operator or automatically by the DO controller.

27. The device of claim 15, further comprising:
an influent pump fluidly connected to the interior of the device and configured to pump wastewater into the interior of the device; and
a mechanical mixer or a mixing gas inlet fluidly connected to the interior of the device and configured to deliver N₂ gas into the interior of the device;
wherein the device is operational within a wide temperature range that includes the range of 10-25° C., or a portion thereof, and produces less bacterial biosolids compared to a previous device.

28-30. (canceled)

31. The device of claim 18, further comprising: a third microorganism, either as at least part of an anaerobic digester sludge or as an acetogenic methanogen, that is encapsulated within a hydrogel matrix within the bulk liquid; wherein the third microorganism is for an anaerobic process that removes carbon from the bulk liquid and prevents biofouling of the device by a heterotroph;
wherein the second microorganism comprises an Anammox bacterium.

32. (canceled)

33. A method for bioremediation, the method comprising:
contacting a bulk liquid with a hollow fiber membrane that comprises an interior that is fluidly connectible with air and an exterior with a biofilm coating thereon that comprises a first microorganism that comprises a comammox, an AOA, an AOB, a NOB, or any combination thereof;
wherein the hollow fiber membrane is permeable to O₂ of the air that is utilizable by the first microorganism for a first process that comprises an aerobic process.

34. The method of claim 33, wherein the AOA comprises a species of the Nitrososphaera genus or N. viennensis.

35. The method of claim 33, wherein the NOB comprises Nitrospira defluvii, a different species of the Nitrospira genus, complete ammonium oxidizing bacteria (comammox), a species that is capable of complete ammonium oxidation via formation of nitrite as an intermediate, or any combination thereof.

36. The method of claim 33, the method further comprising:
contacting the bulk liquid with a hydrogel matrix comprising an Anammox bacterium and an aerobic ammonium oxidizer (AOO) for an anaerobic process;
wherein the Anammox bacterium is positioned toward an interior of the hydrogel matrix and the AOO bacterium is positioned toward an exterior of the hydrogel matrix.

37. (canceled)

38. The method of claim 33, the method further comprising:
contacting the bulk liquid with a hydrogel matrix comprising a third microorganism, either as at least part of an anaerobic digester sludge or as an acetogenic methanogen, that is encapsulated within a hydrogel matrix within the bulk liquid; wherein the third microorganism is for an anaerobic process that removes carbon from the bulk liquid and prevents biofouling of the device by a heterotroph.

39. The method of claim 33, the method further comprising:
monitoring the bulk liquid for DO, pH, and influent/effluent NH₄⁺—N, NO₂⁻ N and NO₃⁻—N concentrations; and
aerating the interior of the hollow fiber membrane with air based on real-time ammonium loading and oxygen demand of microorganisms.

40. The method of claim 33, wherein the method is configured to be performed within a wide temperature range that includes the range of 10-25° C., or a portion thereof, and produces less bacterial biosolids compared to a previous device.

41. (canceled)


SEQUENCE LISTING (14 sequences)

SEQ ID NO: 1 - DNA, 19 bp, synthetic construct
  source 1..19: mol_type = other DNA
gtgycagcmgccgcggtaa

SEQ ID NO: 2 - DNA, 20 bp, synthetic construct
  source 1..20: mol_type = other DNA
ccgycaattymtttragttt

SEQ ID NO: 3 - DNA, 23 bp, synthetic construct
  source 1..23: mol_type = other DNA
atgggcactmrgtagaggggttt

SEQ ID NO: 4 - DNA, 22 bp, synthetic construct
  source 1..22: mol_type = other DNA
cagccatgcaacacctgtrata

SEQ ID NO: 5 - DNA, 18 bp, synthetic construct
  source 1..18: mol_type = other DNA
ggggtttctactggtggt

SEQ ID NO: 6 - DNA, 21 bp, synthetic construct
  source 1..21: mol_type = other DNA
cccctckgsaaagccttcttc

SEQ ID NO: 7 - DNA, 26 bp, synthetic construct
  source 1..26: mol_type = other DNA
atagagcctcaagtaggaaagttcta

SEQ ID NO: 8 - DNA, 26 bp, synthetic construct
  source 1..26: mol_type = other DNA
ccaagcggccatccagctgtatgtcc

SEQ ID NO: 9 - DNA, 16 bp, synthetic construct
  source 1..16: mol_type = other DNA
tacatgtggtggaaca

SEQ ID NO: 10 - DNA, 16 bp, synthetic construct
  source 1..16: mol_type = other DNA
cggttctggtcratca

SEQ ID NO: 11 - DNA, 26 bp, synthetic construct
  source 1..26: mol_type = other DNA
tcaccttgttgctaactagaaactgg

SEQ ID NO: 12 - DNA, 17 bp, synthetic construct
  source 1..17: mol_type = other DNA
tccgcgtgagccaatgt

SEQ ID NO: 13 - DNA, 23 bp, synthetic construct
  source 1..23: mol_type = other DNA
ggtggtgtmggdttcacmcarta

SEQ ID NO: 14 - DNA, 24 bp, synthetic construct
  source 1..24: mol_type = other DNA
cgttcatbgcgtagttvggrtagt